(19) United States
(12) Patent Application Publication
(10) Pub. No.: US 2009/0075734 A1
(43) Pub. Date: Mar. 19, 2009

(54) GAMING APPARATUS EXECUTING RACE BY A PLURALITY OF RACE OBJECTS, AND GAME CONTROL METHOD THEREOF

(75) Inventor: Hiroki SAITO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/194,084

(22) Filed: Aug. 19, 2008

(30) Foreign Application Priority Data
Aug. 22, 2007 (JP) 2007-216229

(51) Int. Cl. A63F 13/00; A63F 9/24

(52) U.S. Cl. 463/37; 463/6; 463/25; 463/43; 463/29

(57) ABSTRACT

A gaming apparatus and a game controlling method in which a plurality of game objects, including game objects belonging to a first group and game objects belonging to a second group, appear in a game, and during the game, based on game object data showing one selected game object belonging to the first group and game object data showing one selected game object belonging to the second group, a special game object data showing a special game object that is different from any of those game objects is determined.

### CROSS-REFERENCE TO RELATED APPLICATIONS

This application claims benefit of priority based on Japanese Patent Application No. 2007-216229 filed on Aug. 22, 2007. The contents of this application are incorporated herein by reference in their entirety.

### BACKGROUND OF THE INVENTION

### Field of the Invention

The present invention relates to a gaming apparatus that executes a race by a plurality of race objects, and a game control method thereof.

Conventionally, there have been known gaming apparatuses for execution of a racing game in which a plurality of race objects contend with one another for winning, such as horse racing game apparatuses (see U.S. Pat. No. 6,210,275, U.S. Pat. No. 6,358,150, U.S. Pat. No. 6,450,887, U.S. Pat. No. 6,634,944, JP-A2001-87461, U.S. Pat. No. 6,848,991, JP-B3291287, U.S. Pat. No. 6,905,410, JP-B3366308, U.S. Pat. No. 6,921,331, U.S. Pat. No. 6,929,550, JP-A 2002-85852, U.S. Pat. No. 6,962,529, JP-A 2002-035429, U.S. Pat. No. 7,025,353, and U.S. Pat. No. 7,172,508). In general, a player who plays on the gaming apparatus of this kind predicts which race object will win based on information provided from the gaming apparatus or intuitive prediction, and bets game media such as medals on the race object. Thereafter, the player can receive a payout depending on the result of the race and the bet game media.

The contents of U.S. Pat. No. 6,210,275, U.S. Pat. No. 6,358,150, U.S. Pat. No. 6,450,887, U.S. Pat. No. 6,634,944, JP-A 2001-87461, U.S. Pat. No. 6,848,991, JP-B 3291287, U.S. Pat. No. 6,905,410, JP-B 3366308, U.S. Pat. No. 6,921,331, U.S. Pat. No. 6,929,550, JP-A 2002-85852, U.S. Pat. No. 6,962,529, JP-A 2002-035429, U.S. Pat. No. 7,025,353, and U.S. Pat. No. 7,172,508 are incorporated herein by reference in their entirety.

The foregoing horse racing game apparatus provides a game patterned after an actual horse racing. However, in the horse racing game apparatus, existing horses do not actually run in a race right in front of players as in the actual horse racing, and there has thus been a problem that the gaming machine lacks realness and looks inferior to the actual horse racing. Further, there has been a problem that, since horses that appear in a game are unfamiliar horses for the player, it is not possible to make the player feel attached to the horses and empathize with the game, and thus not possible to make the player sufficiently absorbed in the game.

Further, there has also been a problem that, since relatively a small number of horses repeatedly appear, the player having played the game for a given period of time or longer remembers all the horses having appeared and gets bored of the game.

The present invention was made in view of the foregoing problems, and has an object to provide a gaming apparatus and a game controlling method in which game objects appearing in a game are diversified and a game object to which a player feels attached appears so that it is possible to prevent the player from getting bored and to make the player absorbed in the game.

### SUMMARY OF THE INVENTION

In order to solve the foregoing problems, the present invention provides the following.

(1) A gaming apparatus, comprising:

an input device with which a player can input a command;

a storage device that stores a plurality of game object data showing a plurality of game objects appearing in a game; and

a controller,

the gaming apparatus providing a racing game in which a plurality of race objects selected from the plurality of game objects contend with one another for winning,

the plurality of game objects shown by the plurality of game object data stored in the storage device including a plurality of game objects belonging to a first group and a plurality of game objects belonging to a second group different from the first group,

the controller being programmed to execute processing of

(A) accepting from the input device respective inputs indicating selection of one game object belonging to the first group and one game object belonging to the second group, and

(B) determining special game object data showing a special game object different from either the one game object belonging to the first group which has been selected in the processing (A) or the one game object belonging to the second group which has been selected in the processing (A), based on the respective game object data showing those game objects.

According to the invention of (1), a plurality of game objects (e.g. racehorse) appear in a game. The plurality of game objects include game objects (e.g. stallions) belonging to a first group and game objects (e.g. mares) belonging to a second group.

During the game, respective inputs indicating selection of one game object belonging to the first group and one game object belonging to the second group are accepted. Based upon game object data showing the selected one game object belonging to the first group and game object data showing the selected one game object belonging to the second group, special game object data showing a special game object (e.g. colt) that is different from either of the above game objects is determined.

Hence the player can create a new special game object based upon two game objects of his or her own selection. Since the player himself or herself is involved in creation of the special game object, the player feels attached to the special game object and can easily empathize with the game. Therefore, according to the invention of (1), it is possible to prevent the player from getting bored of the game in a short period of time, and also possible to make the player absorbed in the game.

Further, the present invention provides the following.

(2) The gaming apparatus according to the above-mentioned (1),

wherein

the input device is provided in each of a plurality of stations, and

the processing (A) is processing of accepting respective inputs indicating selection of one game object belonging to the first group and one game object belonging to the second group, from the input device provided in the station that satisfies a prescribed condition.

According to the invention of (2), at the station that satisfies a prescribed condition, the respective inputs indicating selection of one game object belonging to the first group and one game object belonging to the second group are accepted.

As thus described, according to the invention of (2), since only a player playing a game at the station that satisfies the prescribed condition can create the special game object, it is possible to provide such a player with feelings of superiority and satisfaction, so as to make the player fully enjoy the game.

Further, the present invention provides the following.

(3) The gaming apparatus according to the above-mentioned (2), wherein

the input device is a device with which a player can input a BET on the racing game,

the controller is further programmed to execute processing of

(C) accepting the BET on the racing game from each of the input devices, and

the prescribed condition is that a BET of game media is inputted in an amount not smaller than a prescribed amount from the input device in the processing (C).

According to the invention of (3), only at the station where game media were bet in an amount not smaller than a prescribed amount, the respective inputs indicating selection of one game object belonging to the first group and one game object belonging to the second group are accepted. Therefore, it is possible to prompt the player to bet game media in the amount not smaller than the prescribed amount, so as to increase a profit of a gaming facility.

Further, the present invention provides the following.

(4) The gaming apparatus according to the above-mentioned (2),

wherein

the controller is further programmed to execute processing of

(D) determining whether or not to accept the inputs in the processing (A) at a prescribed timing, and

the prescribed condition is that acceptance of the inputs has been determined in the processing (D).

According to the invention of (4), whether or not the respective inputs indicating selection of one game object belonging to the first group and one game object belonging to the second group are accepted is determined at the prescribed timing. Therefore, since the timing at which the special game object can be created is not previously determined, it is possible to make the player play a game while always expecting for the timing. When such a timing arrives, the player can feel a great joy and a certain kind of surprise so that it becomes possible to provide an extremely attractive game.

Further, the present invention provides the following.

(5) The gaming apparatus according to the above-mentioned (1),

wherein

the controller is further programmed to execute processing of

(E) offering an award based on the game objects selected in the processing (A).

According to the invention of (5), a payout is offered based on the selected game object belonging to the first group and the selected game object belonging to the second group. Accordingly, the player can create the special game object and can further obtain game media. Therefore, the player can feel great satisfaction.

Further, the present invention provides the following.

(6) The gaming apparatus according to the above-mentioned (5),

wherein

a payout amount is correspondingly set for each of the game objects belonging to the first group and each of the game objects belonging to the second group, and

the amount of payout offered in the processing (E) is an amount obtained by multiplying the sum of the payout amount set corresponding to the game object belonging to the first group which was selected in the processing (A) and the payout amount set corresponding to the game object belonging to the second group which was selected in the processing (A), by a number specified by a combination of those game objects.

According to the invention of (6), payout amounts are respectively set corresponding to the game objects belonging to the first group and the game objects belonging to the second group (e.g. based on basic abilities of such as speed and stamina of racehorses). Then, a payout is offered in an amount obtained by multiplying the sum of the payout amount set corresponding to the selected game object belonging to the first group and the payout amount set corresponding to the selected game object belonging to the second group by a number specified by a combination of those game objects.

Accordingly, the amount of the payout to be offered is influenced not simply by the payout amounts set corresponding to the two selected game objects, but also by a combination of the selected game objects (e.g. affinity between the selected two game objects). For this reason, the player carefully considers which combination of the game objects leads to acquirement of game media in as large an amount as possible. The player can experience a variety of emotional ups and downs through the game, for example, the player is shocked when only a small amount of game media is offered, and on the other hand, the player feels pleasure when a large amount of payout is offered. By going through the aforementioned process, the player can fully enjoy the game.

(7) The gaming apparatus according to the above-mentioned (5),

wherein

the controller is further programmed to execute processing of

(F) accepting from the input device an input indicating naming of the special game object shown by the special game object data determined in the processing (B) when a prescribed name-input condition is satisfied.

According to the invention of (7), when a prescribed name-input condition is satisfied, an input indicating naming of the special gaming object is accepted. Since the player can name the game object created by himself or herself, the player further feels attached to the special game object, and thus can further easily empathize with the game.

Further, the present invention provides the following.

(8) The gaming apparatus according to the above-mentioned (7), wherein

the prescribed name-input condition is that the amount of payout offered in the processing (E) is not smaller than a prescribed amount.

According to the invention of (8), in a case where the payout amount that is offered when the two game objects are selected is not smaller than a prescribed amount, an input indicating naming of the special gaming object is accepted. Therefore, which game object to select is important matter for the player, since it involves not only the amount of payout but also whether or not the privilege of naming the special game object will be given. By going through the important selection, the player can enjoy sense of tension and, when the player can select a combination of the game objects corresponding to a large payout amount, the player further enjoy sense of joy and accomplishment.

Further, the present invention provides the following.

(9) The gaming apparatus according to the above-mentioned (1), comprising

a special storage device capable of storing the special game object data,

wherein

the controller is further programmed to execute processing of

(G) selecting a plurality of race objects to participate in the racing game at least out of a plurality of game objects shown by a plurality of the game object data stored in the storage device, and

(H) storing the special game object data determined in the processing (B) in the special storage device, and

the processing (G) is processing of selecting the plurality of race objects out of the special game object shown by the special game object data and the plurality of game objects shown by the plurality of game object data when the special game object data is stored in the special storage device in the processing (H).

According to the invention of (9), special game object data is stored in a special storage device. When the special game object data is stored in the special storage device, a plurality of race objects are selected out of the special game object shown by the special game object data and the plurality of game objects shown by the plurality of game object data.

As thus described, according to the invention of (9), the opportunity to participate in the race game is also given to the special game object. When the game object created by the player himself or herself runs in the race, the player feels attached to the special game object and empathizes with and is excited over the game to an enormous degree. The player can fully enjoy the game by placing a BET on or cheer the game object created by the player.

Further, the present invention provides the following.

(10) The gaming apparatus according to the above-mentioned (9), an upper limit is set for the number of the special game object data that can be stored in the special storage device, and

the controller is further programmed to execute processing of

(I) deleting any of the special game object data stored in the special storage device based on an input from the input device when the special game object data is determined in the processing (B) in a case where the special game object data are stored in number indicated by the upper limit in the special storage device.

According to the invention of (10), an upper limit is set for the number of special game object data that can be stored in the special storage device. In a case where the special game object data in number indicated by the upper limit is stored in the special storage device, when special game object data is further determined, any of the special game object data stored in the special storage device is deleted.

As thus described, according to the invention of (10), since the number of special game object data does not become a given number or larger, it is possible to keep a memory space used for storing the special game object data within a given range, and also to prevent a decrease in scarcity value of special game object data that would be in a case when the special game object data are unlimitedly stored.

Further, the present invention provides the following.

(11) The gaming apparatus according to the above-mentioned (9), wherein

the controller is further programmed to execute processing of

(J) deleting the special game object data stored in the storage device in the processing (H), when a prescribed game completion condition is established.

According to the invention of (11), the special game object data stored in the special storage device is deleted when a prescribed game end condition is established. Therefore, when the player completes the game, the special game object created by the player will no longer run in the race. One special game object is not familiar for players other than a player having created the special game object. According to the invention of (11), it is possible to avoid a situation in which such an unfamiliar special game object runs to offend other players.

Further, the present invention provides the following.

(12) The gaming apparatus according to the above-mentioned (9), comprising

an insertion/removal portion, into and from which an external storage device capable of storing the special game object data can be inserted or removed, and

the controller is further programmed to execute processing of

(K) storing the special game object data, stored in the special storage device by the processing (H), into the external storage device inserted in the insertion/removal portion.

According to the invention of (12), the special game object data stored in the special storage device can be stored in an external storage device. As a result of this, the player can keep the special game object created by himself or herself in the external storage device of his or her own. Then, when a next game is played on the gaming machine, by reading the external storage device, it is possible to make the special game object again appear in the game. Hence the player can perpetually enjoy the game by the use of the once acquired special game.

Further, the present invention provides the following.

(13) A game controlling method providing a racing game in which a plurality of race objects, selected from a plurality of game objects appearing in a game, contend with one another for winning,

the plurality of game objects including a plurality of game objects belonging to a first group and a plurality of game objects belonging to a second group different from the first group,

the game controlling method including the steps of

(A) accepting respective inputs indicating selection of one game object belonging to the first group and one game object belonging to the second group, and

(B) determining special game object data showing a special game object different from either the one game object belonging to the first group which has been selected in the step (A) or the one game object belonging to the second group which has been selected in the step (A), based on the respective game object data showing those game objects.

According to the invention of (13), a plurality of game objects (e.g. racehorse) appear in a game. The plurality of game objects include game objects (e.g. stallions) belonging to a first group and game objects (e.g. mares) belonging to a second group.

During the game, respective inputs indicating selection of one game object belonging to the first group and one game object belonging to the second group are accepted. Based upon game object data showing the selected one game object belonging to the first group and game object data showing the selected one game object belonging to the second group, special game object data showing a special game object (e.g. colt) that is different from either of the above game objects is determined.

Hence the player can create a new special game object based upon two game objects of his or her own selection. Since the player himself or herself is involved in creation of the special game object, the player feels attached to the special game object and can easily empathize with the game. Therefore, according to the invention of (13), it is possible to prevent the player from getting bored of the game in a short period of time, and also possible to make the player absorbed in the game.

Further, the present invention provides the following.

(14) The game controlling method according to the above (13), wherein

the step (A) is a step of accepting respective inputs indicating selection of one game object belonging to the first group and one game object belonging to the second group in the station that satisfies a prescribed condition.

According to the invention of (14), at the station that satisfies a prescribed condition, the respective inputs indicating selection of one game object belonging to the first group and one game object belonging to the second group are accepted.

As thus described, according to the invention of (14), since only a player playing a game at the station that satisfies the prescribed condition can create the special game object, it is possible to provide such a player with feelings of superiority and satisfaction, so as to make the player fully enjoy the game.

Further, the present invention provides the following.

(15) The game controlling method according to the above-mentioned (14), including a step of

(C) accepting the BET on the racing game,

wherein

the prescribed condition is that a BET of game media is placed in an amount not smaller than a prescribed amount.

According to the invention of (15), only at the station where game media were bet in an amount not smaller than a prescribed amount, the respective inputs indicating selection of one game object belonging to the first group and one game object belonging to the second group are accepted. Therefore, it is possible to prompt the player to bet game media in the amount not smaller than the prescribed amount, so as to increase a profit of a gaming facility.

Further, the present invention provides the following.

(16) The game controlling method according to the above-mentioned (14), including a step of

(D) determining whether or not to accept the inputs in the step (A) at a prescribed timing,

wherein

the prescribed condition is that acceptance of the inputs has been determined in the step (D).

According to the invention of (16), whether or not the respective inputs indicating selection of one game object belonging to the first group and one game object belonging to the second group are accepted is determined at the prescribed timing. Therefore, since the timing at which the special game object can be created is not previously determined, it is possible to make the player play a game while always expecting for the timing. When such a timing arrives, the player can feel a great joy and a certain kind of surprise so that it becomes possible to provide an extremely attractive game.

Further, the present invention provides the following.

(17) The game controlling method according to the above-mentioned (13), including a step of

(E) offering an award based on the game objects selected in the step (A).

According to the invention of (17), a payout is offered based on the selected game object belonging to the first group and the selected game object belonging to the second group. Accordingly, the player can create the special game object and can further obtain game media. Therefore, the player can feel great satisfaction.

Further, the present invention provides the following.

(18) The game controlling method according to the above-mentioned (17), wherein

a payout amount is correspondingly set for each of the game objects belonging to the first group and each of the game objects belonging to the second group, and

the amount of payout offered in the step (E) is an amount obtained by multiplying the sum of the payout amount set corresponding to the game object belonging to the first group which was selected in the step (A) and the payout amount set corresponding to the game object belonging to the second group which was selected in the step (A), by a number specified by a combination of those game objects.

According to the invention of (18), payout amounts are respectively set corresponding to the game objects belonging to the first group and the game objects belonging to the second group (e.g. based on basic abilities of such as speed and stamina of racehorses). Then, a payout is offered in an amount obtained by multiplying the sum of the payout amount set corresponding to the selected game object belonging to the first group and the payout amount set corresponding to the selected game object belonging to the second group by a number specified by a combination of those game objects.

Accordingly, the amount of the payout to be offered is influenced not simply by the payout amounts set corresponding to the two selected game objects, but also by a combination of the selected game objects (e.g. affinity between the selected two game objects). For this reason, the player carefully considers which combination of the game objects leads to acquirement of game media in as large an amount as possible. The player can experience a variety of emotional ups and downs through the game, for example, the player is shocked when only a small amount of game media is offered, and on the other hand, the player feels pleasure when a large amount of payout is offered. By going through the aforementioned process, the player can fully enjoy the game.

Further, the present invention provides the following.

(19) The game controlling method according to the above-mentioned (17),

The game controlling method according to claim 17 or 18, including a step of

(F) accepting from an input device an input indicating naming of the special game object shown by the special game object data determined in the step (B) when a prescribed name-input condition is satisfied.

According to the invention of (7), when a prescribed name-input condition is satisfied, an input indicating naming of the special gaming object is accepted. Since the player can name the game object created by himself or herself, the player further feels attached to the special game object, and thus can further easily empathize with the game.

Further, the present invention provides the following.

(20) The game controlling method according to the above-mentioned (19), wherein

the prescribed name-input condition is that the amount of payout offered in the step (E) is not smaller than a prescribed amount.

According to the invention of (20), in a case where the payout amount that is offered when the two game objects are selected is not smaller than a prescribed amount, an input indicating naming of the special gaming object is accepted. Therefore, which game object to select is important matter for the player, since it involves not only the amount of payout but also whether or not the privilege of naming the special game object will be given. By going through the important selection, the player can enjoy sense of tension and, when the player can select a combination of the game objects corresponding to a large payout amount, the player further enjoy sense of joy and accomplishment.

Further, the present invention provides the following.

(21) The game controlling method according to the above-mentioned (13), including the steps of

(G) selecting a plurality of race objects to participate in the racing game at least out of a plurality of the game objects shown by a plurality of game object data stored in the storage device, and

(H) storing the special game object data determined in the step (B) in a special storage device, wherein

the step (G) is a step of selecting the plurality of race objects out of the special game object shown by the special game object data and the plurality of game objects shown by the plurality of game object data when the special game object data is stored in the special storage device in the step (H).

According to the invention of (21), special game object data is stored in a special storage device. When the special game object data is stored in the special storage device, a plurality of race objects are selected out of the special game object shown by the special game object data and the plurality of game objects shown by the plurality of game object data.

As thus described, according to the invention of (21), the opportunity to participate in the race game is also given to the special game object. When the game object created by the player himself or herself runs in the race, the player feels attached to the special game object and empathizes with and is excited over the game to an enormous degree. The player can fully enjoy the game by placing a BET on or cheer the game object created by the player.

Further, the present invention provides the following.

(22) The game controlling method according to the above-mentioned (21), wherein

an upper limit is set for the number of the special game object data that can be stored in the special storage device, and

the method includes a step of

(I) deleting any of the special game object data stored in the special storage device based on an input from the input device when the special game object data is determined in the step (B) in a case where the special game object data are stored in number indicated by the upper limit in the special storage device.

According to the invention of (22), an upper limit is set for the number of special game object data that can be stored in the special storage device. In a case where the special game object data in number indicated by the upper limit is stored in the special storage device, when special game object data is further determined, any of the special game object data stored in the special storage device is deleted.

As thus described, according to the invention of (22), since the number of special game object data does not become a given number or larger, it is possible to keep a memory space used for storing the special game object data within a given range, and also to prevent a decrease in scarcity value of special game object data that would be in a case when the special game object data are unlimitedly stored.

Further, the present invention provides the following.

(23) The game controlling method according to the above-mentioned (21), including a step of

(J) deleting the special game object data stored in the special storage device in the step (H), when a prescribed game completion condition is established.

According to the invention of (23), the special game object data stored in the special storage device is deleted when a prescribed game end condition is established. Therefore, when the player completes the game, the special game object created by the player will no longer run in the race. One special game object is not familiar for players other than a player having created the special game object. According to the invention of (23), it is possible to avoid a situation in which such an unfamiliar special game object runs to offend other players.

Further, the present invention provides the following.

(24) The game controlling method according to the above-mentioned (21), including a step of

(K) storing the special game object data stored in the special storage device in the step (H), in the external storage device inserted in an insertion/removal portion, into and from which the external storage device can be inserted and removed.

According to the invention of (24), the special game object data stored in the special storage device can be stored in an external storage device. As a result of this, the player can keep the special game object created by himself or herself in the external storage device of his or her own. Then, when a next game is played on the gaming machine, by reading the external storage device, it is possible to make the special game object again appear in the game. Hence the player can perpetually enjoy the game by the use of the once acquired special game.

According to the present invention, it is possible to provide a gaming apparatus and a game controlling method in which game objects appearing in a game are diversified and a game object to which a player feels attached appears. so that it is possible to prevent the player from getting bored and to make the player absorbed in the game

### BRIEF DESCRIPTION OF THE DRAWINGS

FIG. 1 is a view showing an example of images displayed on a sub-monitor installed in a station provided in a horse racing game apparatus according to the present embodiment.

FIG. 2 is a perspective view schematically showing an example of the horse racing game is a perspective view schematically showing an example of the horse racing game apparatus according to the present embodiment.

FIG. 3 is a perspective view schematically showing an example of the stations shown in FIG. 2.

FIG. 4 is a block diagram showing an internal configuration of a main game portion provided in the horse racing game apparatus shown in FIG. 2.

FIG. 5 is a block diagram showing an internal configuration of the station provided in the horse racing game apparatus shown in FIG. 2.

FIG. 6 is a view schematically showing an example of BET images displayed on a sub-monitor.

FIG. 7 is a flowchart showing an example of game operations in the horse racing game apparatus in the present embodiment.

FIG. 8 is a flowchart showing an example of the game operations in the horse racing game apparatus in the present embodiment.

FIG. 9 is a flowchart showing an example of the game operations in the horse racing game apparatus in the present embodiment.

FIG. 10 is a flowchart showing a subroutine of racehorse decision processing performed in a main control portion.

FIG. 11 is a flowchart showing a subroutine of racing game execution processing performed in the main control portion.

FIG. 12 is a flowchart showing a subroutine of colt data deletion processing performed in the main control portion and a sub-control portion.

FIG. 13 is a flowchart showing a subroutine of colt data reading processing performed in the main control portion and the sub-control portion.

FIG. 14 is a flowchart showing a subroutine of colt data writing processing performed in the sub-control portion.

### DESCRIPTION OF THE EMBODIMENTS

An embodiment of the present invention is described below based on the drawings. In the following, the case of applying the present invention to a horse racing game apparatus is described as a preferred embodiment of the present invention.

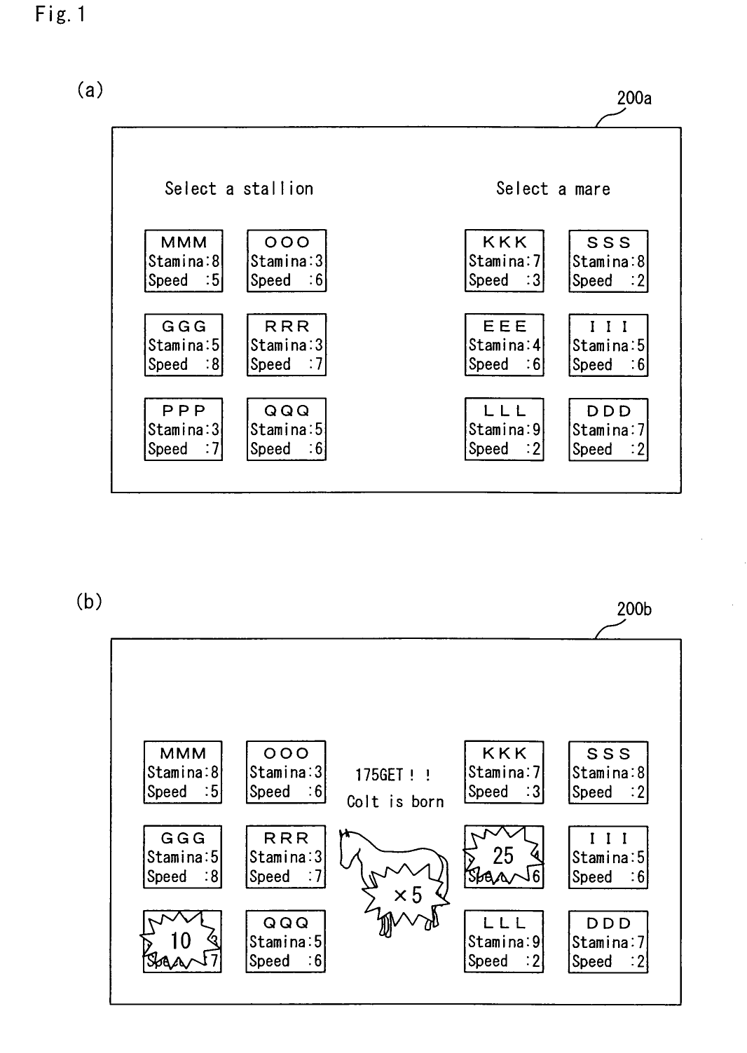

FIGS. 1A and 1B are views each showing an example of images displayed to a sub-monitor installed in a station provided in a horse racing game apparatus according to the present embodiment.

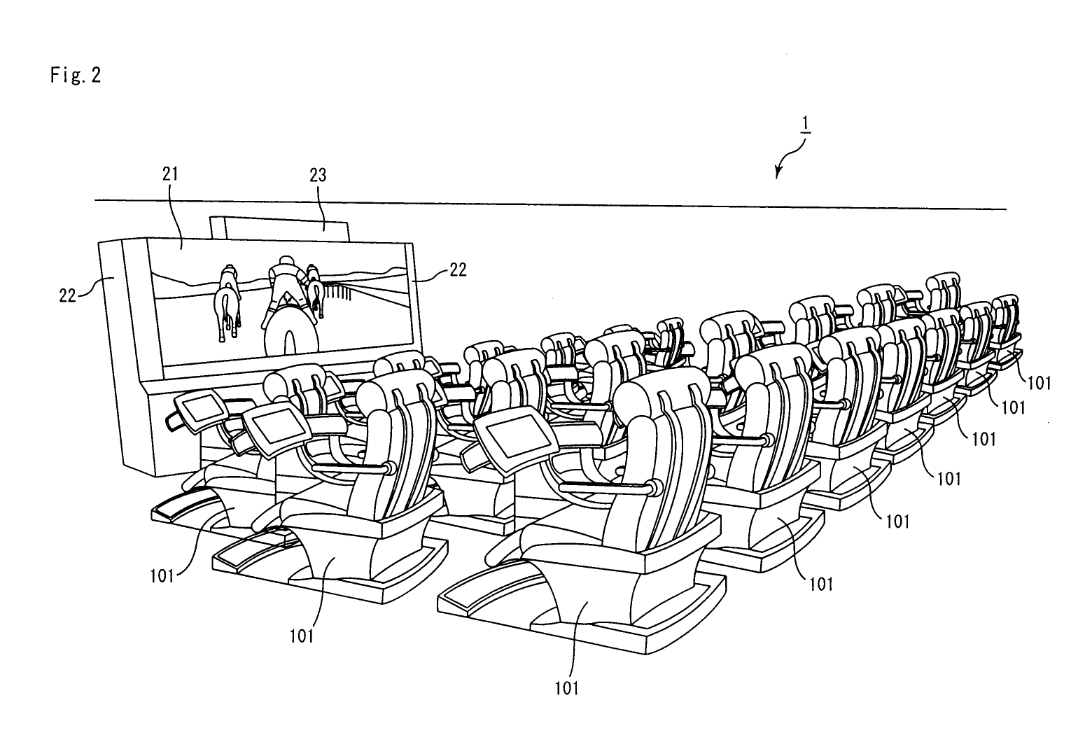

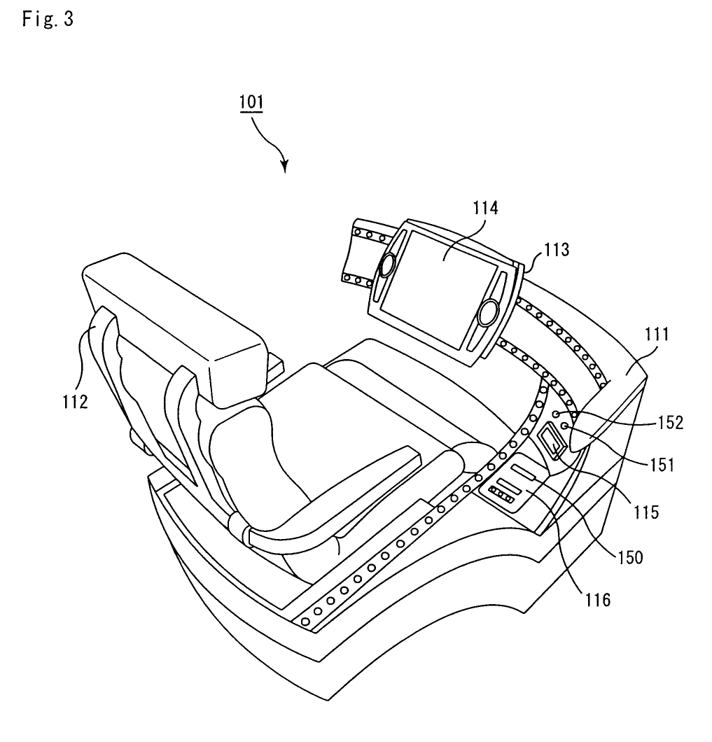

A horse racing game apparatus 1 according to the present embodiment includes a plurality of stations 101 with which a plurality of players respectively input commands (e.g. BETs) relating to a horse racing game so as to play the horse racing game (see FIG. 2). Further, each station 101 has a sub-monitor 113 (see FIG. 3). The images shown in FIG. 1 are examples of images displayed to the sub-monitor 113.

In the horse racing game, a race in which a plurality of virtual racehorses contend with one another for winning is executed. The player predicts which horserace will win and places a BET. The race corresponds to the racing game in the present invention. In the present specification, a combination of a BET placed by a player and a race (racing game) by racehorse is referred to as a horse racing game.

The horserace corresponds to the race object in the present invention. Further, the horserace is included in the game objects in the present invention. The game objects in the present invention include stallions and mares other than racehorse. The stallions correspond to the game objects belonging to a first group in the present invention. The mares correspond to the game objects belonging to a second group in the present invention.

In the present embodiment, the stallions and the mares are different from the racehorse. However, in the present invention, the game objects belonging to the first group and the game objects belonging to the second group may be the same as the race objects.

In the present embodiment, after a race ends, an event in which a colt can be created from a stallion and a mare (hereinafter referred to as a colt creation bonus) is generated in the station 101 that satisfies a prescribed condition.

Here, the prescribed condition is as follows:

condition (i): a BET in amount not smaller than a prescribed amount has been placed, and

condition (ii): it is determined the colt creation bonus will be generated by a sub-control portion 102 provided in the station 101.

In the present embodiment, the colt creation bonus is generated in the station 101 that satisfies the above conditions (i) and (ii).

The prescribed condition in the present invention is not limited to this example. Examples of the condition may include a condition that a payout amount in a horse racing game is not smaller than a prescribed amount, a condition that horse racing games have been successively played for a prescribed number of times, and the like.

When the colt creation bonus is generated, as shown in FIG. 1A, a selection image 200a prompting the player to select a stallion and a mare is displayed to the sub-monitor 113. The player can select an arbitrary stallion and an arbitrary mare through the touch panel. The player can select arbitrary stallion and mare through a touch panel.

When the player selects the stallion and the mare, as shown in FIG. 1B, a colt birth image 200b showing that a colt has been born is displayed. As thus described, in the colt creation bonus, the player can select a stallion and a mare, to create a colt. Further, the player can acquire a payout based upon the selected stallion and mare, and the born colt. At the center of FIG. 1B, an image “175 GET!!” is displayed, showing an amount of payout that the player can acquire is displayed.

Moreover, when a payout amount is a prescribed amount (e.g. 150 credits or more), the player can name the born colt and save this colt. The saved colt may participate in a race in a horse racing game.

It is to be noted that the colt created and stored in the station is deleted when the state of the number of credits being 0 is kept for a prescribed time or more. Further, the player can store the created colt in a memory card 50 (external storage device).

FIG. 2 is a perspective view schematically showing an example of horse racing game apparatuses according to the present embodiment.

The horse racing game apparatus 1 includes: the main monitor 21; speakers 22 installed on both the right and left sides of the main monitor 21; an indicator 23 installed on a top of the main monitor 21; and the plurality of stations 101 installed so as to face the main monitor 21.

To the main monitor 21, an image showing the progress of a race, an image showing information based on bets, and the like, are displayed. From the speakers 22, a sound in accordance with the progress of the race is outputted. To the indicator 23, information regarding the game in general and the like are displayed.

FIG. 3 is a perspective view schematically showing an example of the stations shown in FIG. 2.

The station 101 has: a cabinet 111, a chair 112 installed inside the cabinet 111; a sub monitor 113 installed on the cabinet 111 so as to face the chair 112; a touch panel 114 installed on the screen of the sub monitor 113; a bill validator 115 installed on the cabinet 111 to the right of the chair 112; a ticket printer 116 installed below the bill validator 115; a memory card insertion portion 150 installed next to the ticket printer 116; a readout button 151 installed on the upper side of the bill validator 115; and a writing button 152.

On the sub-monitor 113, a later-described bet image, an image showing the progress of a race, and the like, are displayed. The touch panel 114 is used when the player performs input, such as a bet operation using the bet image, selection of a stallion and a mare, determination of the name of a colt, and the like.

The bill validator 115 identifies validity of a bill, and accepts a regular bill into the cabinet 111. The bill accepted into the cabinet 111 is converted into the number of coins at a prescribed rate, and the number of credits corresponding to the number of coins is added to the number of credits owned by the player. It is to be noted that the bill validator 115 may be configured so as to be capable of reading a later-described ticket 39 with a barcode.

The ticket printer 116 prints on a ticket a barcode formed by encoding data such as the number of credits, date and time, and an identification number of the station 101, and outputs the ticket as the ticket 39 with a barcode. The player can make another station read the ticket 39 with a barcode and play a game on that station 101, or exchange the ticket 39 with a barcode with bills or the like at a prescribed place in a gaming facility (e.g. cashier booth in a casino).

The memory card insertion portion 150 is a portion into and from which the memory card 50 can be inserted and removed. The readout button 151 is a button operated in reading colt data stored in the memory card 50. The writing button 152 is a button operated in writing colt data into the memory card 50.

When the player presses down the readout button 151 and performs a prescribed operation, with the memory card 50 inserted in the memory card insertion portion 150, the colt data stored in the memory card 50 can be stored in the RAM 42 provided in the horse racing game apparatus 1.

Further, when the player presses down the writing button 152 and performs a prescribed operation, with the memory card 50 inserted in the memory card insertion portion 150, the colt data stored in the RAM 42 provided in the horse racing game apparatus 1 can be stored in the memory card 50.

The memory card insertion portion 150 corresponds to the insertion/removal portion in the present invention. Further, the readout button 151 and the writing button 152 correspond to the input device in the present invention.

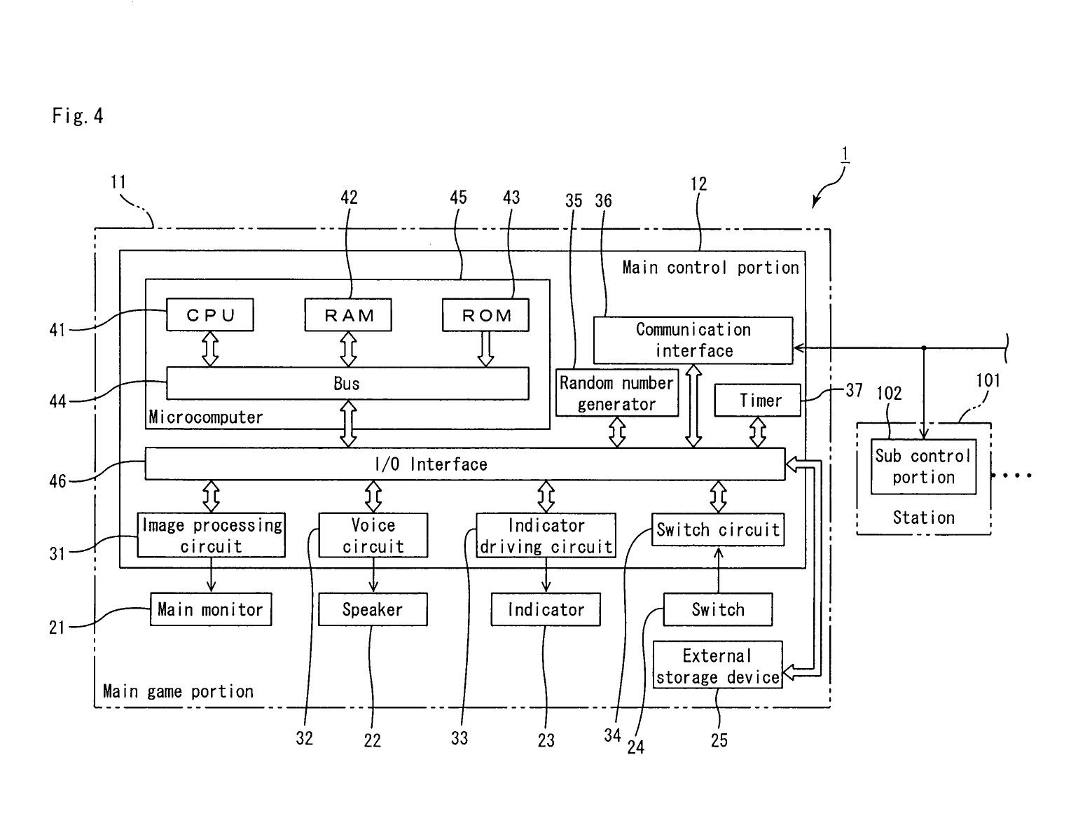

FIG. 4 is a block diagram showing an internal configuration of a main game portion provided in the horse racing game apparatus shown in FIG. 2.

A main game portion 11 is a central portion of the horse racing game apparatus 1 in the present embodiment. The main game portion 11 has a main control portion 12, the main monitor 21, the speakers 22, the indicator 23, a switch 24, and an external storage device 25.

The main control portion 12 has a microcomputer 45, arranged on a circuit board, as a main constituent. The microcomputer 45 has a CPU 41 that performs a control operation in accordance with a previously set program, a RAM 42, and a ROM 43.

The RAM 42 is a memory for temporarily storing a variety of data computed in the CPU 41. Especially, in the present embodiment, colt data showing a created colt is stored in the RAM 42. The RAM 42 is provided with a plurality of colt data storage region 201 for storing colt data, with each of the colt data storage region 201 corresponding to each of the stations 101.

For example, colt data showing a colt created in a station 101a is stored in a colt data storage region 201a. Further, colt data showing a colt created in a station 101b is stored in a colt data storage region 201b. Further, colt data showing a colt created in a station 101c is stored into a colt data storage region 201c.

Moreover, an upper limit (e.g. 5) is set for the number of colt data that can be stored in each of the colt data storage region 201. The RAM 42 corresponds to the special storage device in the present invention.

In the ROM 43, a variety of programs for performing processing required for controlling the horse racing game apparatus 1, information regarding a plurality of racehorses, winning percentage data of each racehorse, and the like are stored.

Particularly, in the present embodiment, a plurality of stallion data respectively showing a plurality of stallions and a plurality of mare data respectively showing a plurality of mares are stored in the ROM 43. The stallion data and the mare data include information regarding stallions and mares. Examples of the information regarding stallions and mares include information showing abilities such as stamina and speed, and information showing a payout amount set corresponding to each stallion and mare.

The ROM 43 corresponds to the storage device in the present invention.

The microcomputer 45 is connected with an image processing circuit 31 through an I/O interface 46. The image processing circuit 31 is connected to the main monitor 21, and controls the drive of the main monitor 21.

The image processing circuit 31 has a program ROM 311, an image ROM 312, an image control CPU 313, a work RAM 314, an image data processor 315 (hereinafter also referred to as a “VDP 315”), and a video RAM 316.

The program ROM 311 stores a program for image control regarding display within the main monitor 21, and a variety of selection tables.

Further, the image ROM 312 stores, for example, dot data for forming an image within the main monitor 21 and a variety of image data such as background image data and image data of racehorses.

Further, the image control CPU 313 determines an image to be displayed on the main monitor 21 out of the dot data and image data previously stored inside the image ROM in accordance with the image control program previously stored inside the program ROM, based on a parameter set in the microcomputer 45.

Further, the work RAM 314 is configured as a temporary storage unit in execution of the image control program in the image control CPU 313.

Furthermore, the VDP 315 generates image data in accordance with display contents determined in the image control CPU 313, and outputs the data to the main monitor 21.

Moreover, the video RAM 316 is configured as a temporary storage unit in formation of an image in the VDP 315.

The microcomputer 45 is connected with a voice circuit 32 through the I/O interface 46. The voice circuit 32 is connected with the speakers 22. The speakers 22 are provided on the right and left sides of the main monitor 21, and output a sound under output-control by the voice circuit 32, based on a drive signal from the CPU 41.

The microcomputer 45 is connected with an indicator driving circuit 33 through the I/O interface 46. The indicator driving circuit 33 is connected with the indicator 23. The indicator 23 is provided on the top of the main monitor 21, and displays information regarding a game in general, and the like, under display-control by the indicator driving circuit 33, based on a drive signal from the CPU 41.

The microcomputer 45 is connected with a switch circuit 34 through the I/O interface 46. The switch circuit 34 is connected with the switch 24. The switch 24 is provided below the main monitor 21, and inputs a command by a setting operation performed by an operator into the CPU 41, based on a switch signal from the switch circuit 34.

The microcomputer 45 is connected with a random number generator 35 through the I/O interface 46. The random number generator 35 generates a random number to be sampled by the CPU 41.

The microcomputer 45 is connected with a timer 37 through the I/O interface 46. The timer 37 is used for measuring time at the start of a racing game, and the like.

The microcomputer 45 is connected with the external storage device 25 through the I/O interface 46. The external storage device 25 is provided on the periphery of the main monitor 21. Further, for example, storing the dot data for forming an image and the like into the external storage device 25 allows the external storage device 25 to have a function similar to that of the image ROM 312 inside the image processing circuit 31. Therefore, when determining an image to be displayed on the main monitor 21, the image control CPU 313 inside the image processing circuit 31 also takes the dot data and the like previously stored inside the external storage device 25 as objects for the determination.

The microcomputer 45 is connected with the communication interface 36 through the I/O interface 46. The communication interface 36 is connected with a sub control portion 102 of each of the stations 101. Therefore, the CPU 41 transmits and receives a command, a request, data, and the like, to and from each of the stations 101 through the communication interface 36.

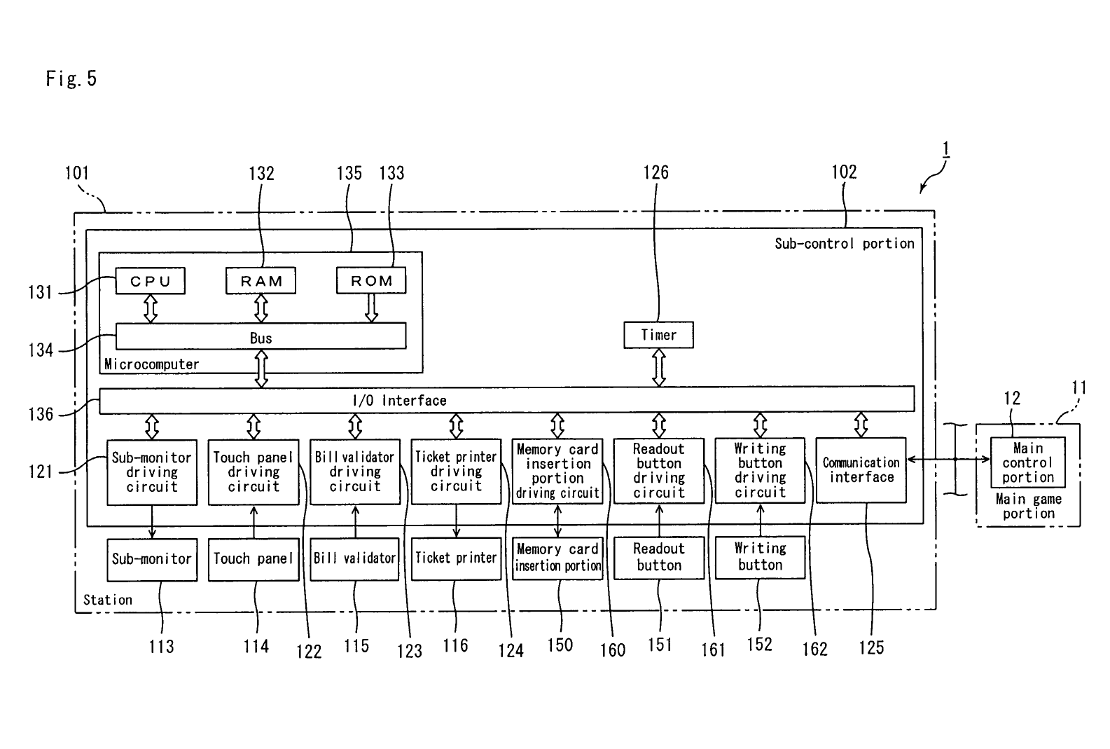

FIG. 5 is a block diagram showing an internal configuration of the station provided in the horse racing game apparatus shown in FIG. 2.

The station 101 includes the sub control portion 102, the sub-monitor 113, the touch panel 114, the bill validator 115, the ticket printer 116, the memory card insertion portion 150, the readout button 151, and the writing button 152.

The sub control portion 102 has the microcomputer 135 arranged on the circuit board, as a main constituent. The microcomputer 135 has a CPU 131 that performs a control operation in accordance with a previously set program, a RAM 132, and a ROM 133.

The RAM 132 is a memory for temporarily storing a variety of data computed in the CPU 131. The ROM 133 stores a variety of programs for performing processing necessary in controlling the horse racing game apparatus 1, a data table, and the like.

The microcomputer 135 is connected with a sub-monitor driving circuit 121 through an I/O interface 136. The sub-monitor driving circuit 121 is connected with the sub-monitor 113. The sub-monitor driving circuit 121 controls the drive of the sub-monitor 113, based on a drive signal from the main game portion 11. The sub-monitor driving circuit 121 has a configuration and function similar to those of the image processing circuit 31, and for example, controls the drive of the sub-monitor 113 so that the selection image 200a or the colt birth image 200b (see FIGS. 1A and 1B) is displayed.

The microcomputer 135 is connected with a touch panel driving circuit 122 through the I/O interface 136. The touch panel driving circuit 122 is connected with the touch panel 114. The touch panel 114 is provided on the screen of the sub-monitor 113, and inputs into the CPU 131a command by a touching operation of the player as a coordinate signal from the touch panel driving circuit 122.

The microcomputer 135 is connected with a bill validator driving circuit 123 through the I/O interface 136. The bill validator driving circuit 123 is connected with the bill validator 115. The bill validator 115 identifies validity of a bill and the ticket 39 with a barcode. When accepting a regular bill, the bill validator 115 inputs the amount of the accepted bill into the CPU 131, based on an identification signal from the bill validator driving circuit 123. Further, when accepting a regular ticket 39 with a barcode, the bill validator 115 inputs into the CPU 131 the number of credits and the like which are recorded on the ticket 39 with a barcode, based on an identification signal from the bill validator driving circuit 123.

The microcomputer 135 is connected with a ticket printer driving circuit 124 through the I/O interface 136. The ticket printer driving circuit 124 is connected with the ticket printer 116. The ticket printer 116 prints on a ticket a barcode formed by encoding data such as the number of owned credits stored in the RAM 132, and the like, and outputs the ticket as the ticket 39 with a barcode under output-control by the ticket printer driving circuit 124, based on a drive signal outputted from the CPU 131.

The microcomputer 135 is connected with a memory card insertion portion-driving circuit 160 via the I/O interface 136. The memory card insertion portion-driving circuit 160 is connected with a memory card insertion portion 150. The memory card insertion portion 150 inputs a signal showing insertion/removal of the memory card 50 in the CPU 131 via the memory card insertion portion-driving circuit 160 when the memory card 50 is inserted or when the memory card 50 is removed. Further, colt data is transmitted and received between the CPU 131 and the memory card 50 via the memory card insertion portion-driving circuit 160.

The microcomputer 135 is connected with a readout button-driving circuit 161 via the I/O interface 136. The readout button-driving circuit 161 is connected with a readout button 151. The readout button 151 inputs a signal indicating readout of colt data from the memory card 50, into the CPU 131 via the readout button-driving circuit 161.

The microcomputer 135 is connected with a writing button-driving circuit 162 via the I/O interface 136. The writing button-driving circuit 162 is connected with a writing button 152. The writing button 152 inputs a signal indicating writing of colt data into the memory card 50, into the CPU 131 via the readout button-driving circuit 161.

The microcomputer 135 is connected with a communication interface 125 through the I/O interface 136. The communication interface 125 is connected with the main control portion 12 of the main game portion 11. Therefore, the CPU 131 transmits and receives a command, a request, data, and the like, to and from the main game portion 11 through the communication interface 125.

The microcomputer 135 is connected with the timer 126 through the I/O interface 136. The timer 126 is used for measuring time in ending acceptance of the bet operation.

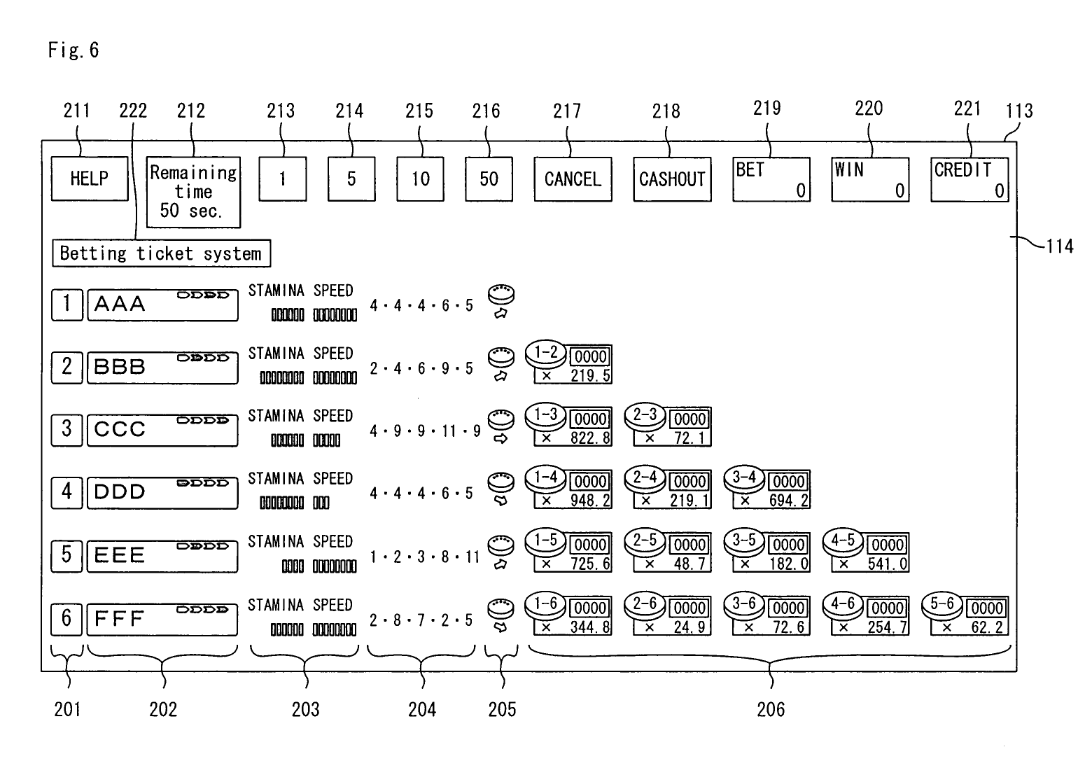

FIG. 6 is a view schematically showing an example of bet images displayed on the sub-monitor. The bet image displayed on the screen of the sub-monitor 113 covered by the touch panel 114 is provided with: a horse number display region 201; a horse name display region 202; a basic ability display region 203 displaying speed and stamina by means of bar charts; a record display region 204 displaying orders of finish in last five races; a condition display region 205 displaying current conditions by means of arrows; and a betting ticket purchase button region 206 displaying, with odds and number of bets, a betting ticket perchance button for quinella in which a combination of horse numbers that will finish first and second in any order is predicted.

Further, the bet image includes images of a help button 211, a 1-bet button 213, a 5-bet button 214, a 10-bet button 215, a 50-bet button 216, a cancel button 217, a cash-out button 218, and a betting ticket system switch button 222.

Moreover, the bet image is provided with a time display region 212, a number-of-bets display region 219, an amount-of-payout display region 220, and a number-of-credits display region 221.

The help button 211 is a button to be touched by the player for displaying an operation method for betting and the like to the sub-monitor 113a. In the time display region 212, remaining time possible for bet-input is displayed. The 1-bet button 213 is a button to be touched by the player for adding “1” to the current number of bets. The 5-bet button 214 is a button to be touched by the player for adding “5” to the current number of bets. The 10-bet button 215 is a button to be touched by the player for adding “10” to the current number of bets. The 50-bet button 216 is a button to be touched by the player for adding “50” to the current number of bets.

The cancel button 217 is a button to be touched by the player for canceling the added number of bets. The cash-out button 218 is a button to be touched by the player for paying out coins in number in accordance with the number of credits owned by the player by means of the ticket 39 with a barcode. In the number-of-bets display region 219, the total number of bets set by the player in the current race is displayed. The amount-of-payout display region 220 displays an amount of payout in the race this time around. In the number-of-credits display region 221, the number of credits owned by the player is displayed.

Although the bet image shown in FIG. 6 is the quinella bet image, every time a betting ticket system switch button 222 is touched, the bet image is switched to win, place, exacta, trifecta, bracket quinella, trio, quinella-place (wide), and the like.

The player touches any of the 1-bet button 213, the 5-bet button 214, the 10-bet button 215, and the 50-bet button 216, and then touches any betting ticket purchase button within the betting ticket purchase button display region 206, so as to place a bet. For example, when touching the 10-bet button 215 and then touching a “1-2” betting ticket purchase button within the betting ticket purchase button display region 206, the player can add “10” to the current number of bets on “1-2”. Here, “1-2” means that a combination of No. 1 horse and No. 2 horse will take first and second place in any order. It is to be noted that the current number of bets on each combination of horse numbers is displayed next to the betting ticket purchase button corresponding to each combination.

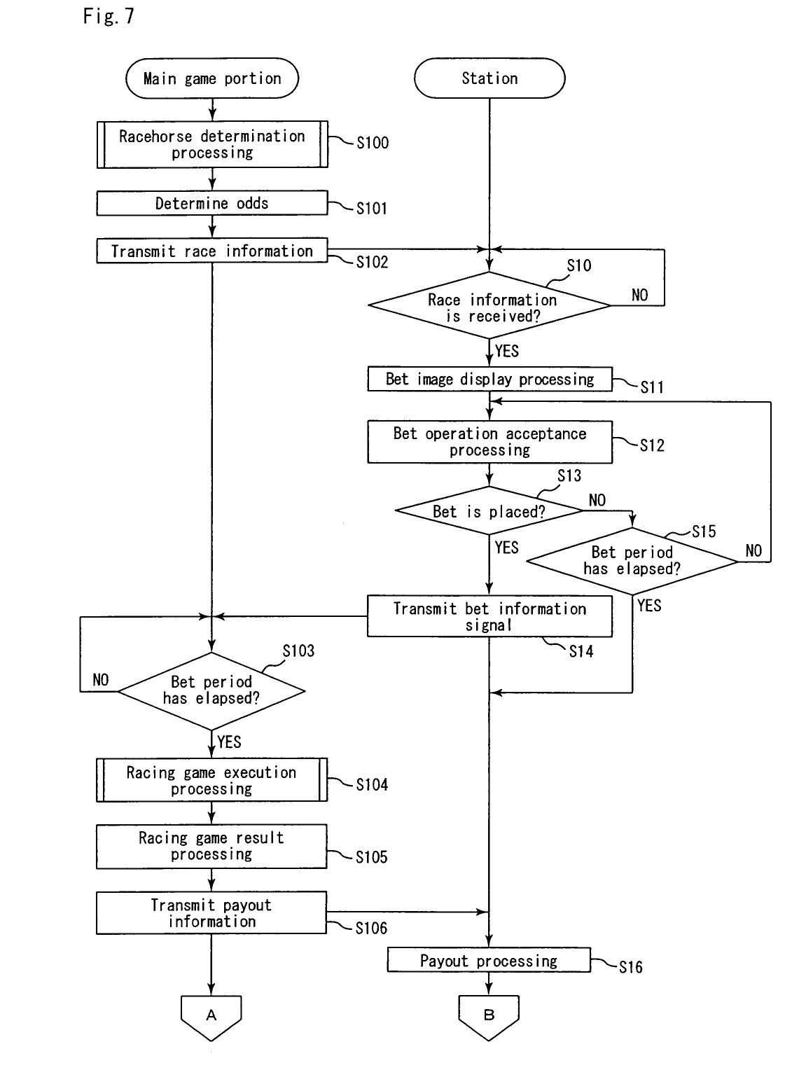

In the following, processing executed in the horse racing game apparatus 1 are described using FIGS. 7 to 14. Among the processing shown in FIGS. 7 to 14, the processing in the main game portion 11 are executed by the main control portion 12. Meanwhile, the processing in the station 101 are executed by the sub-control portion 102. When the main control portion 12 and the sub-control portion 102 operate together to execute the processing of FIGS. 7 to 14, the main control portion 12 and the sub-control portion 102 function as the controller in the present invention.

FIGS. 7 to 9 are flowcharts each showing an example of game operations in the horse racing game apparatus in the present embodiment.

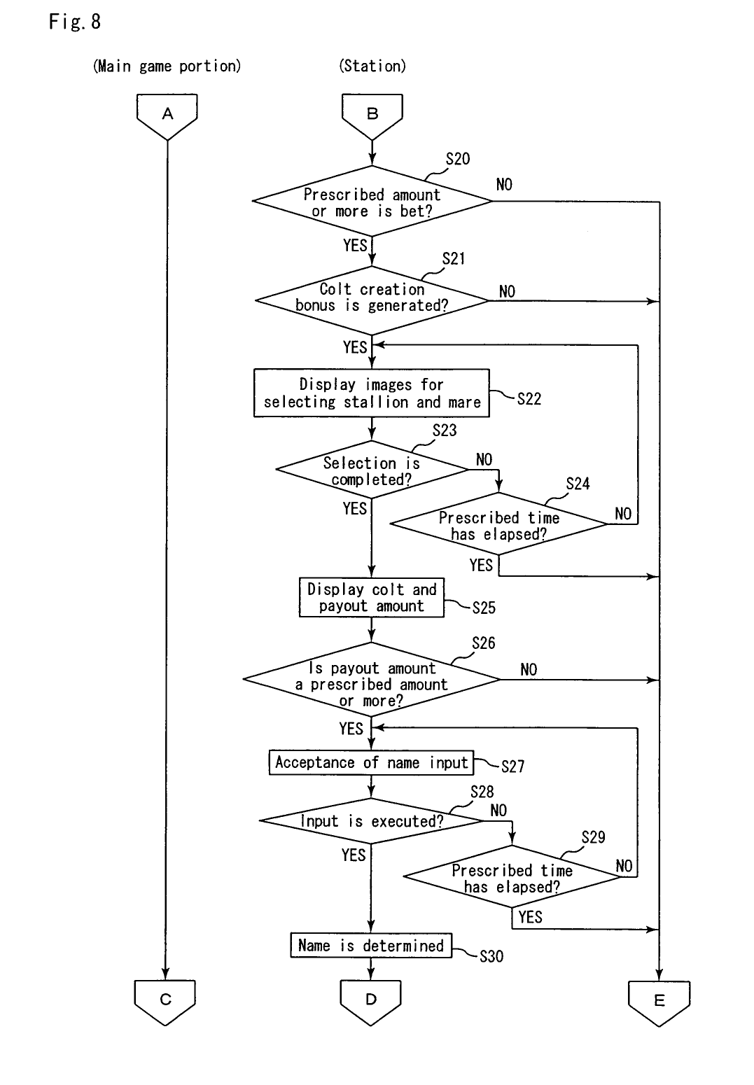

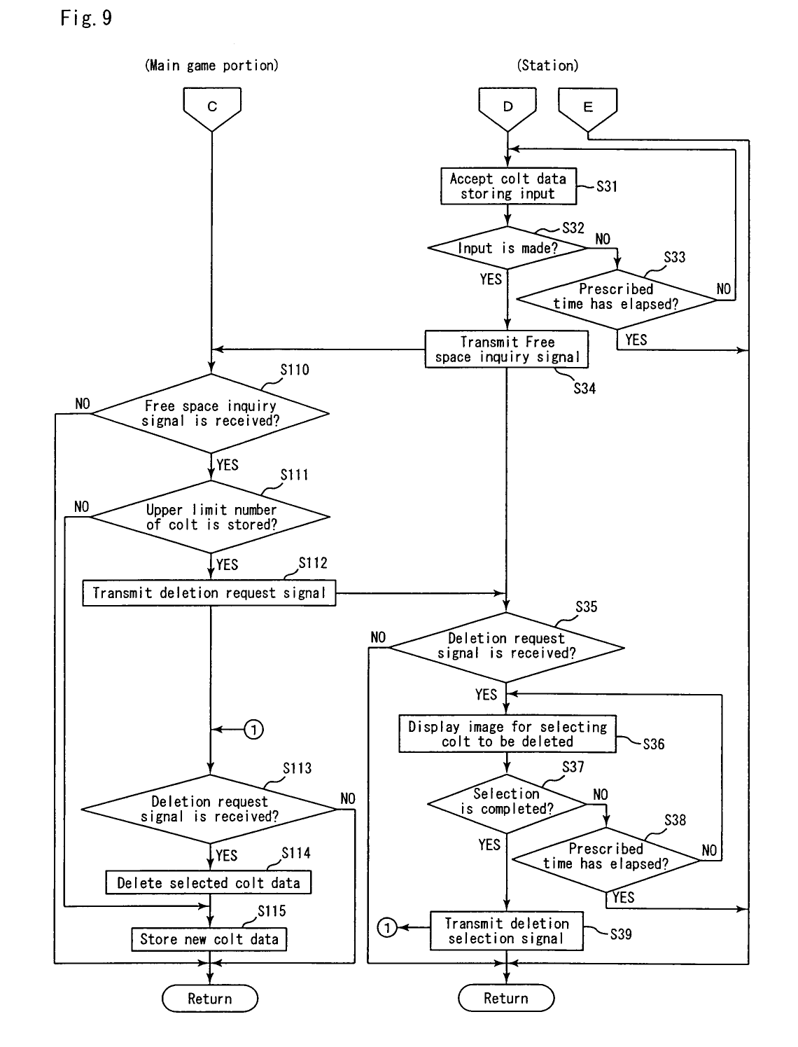

FIG. 7 shows processing relating to the horse racing game, and FIGS. 8 and 9 show processing relating to the colt creation bonus.

First, the processing relating to the horse racing game shown in FIG. 7 is described.

In the main game portion 11, respective operations of steps S100 to S106 are performed.

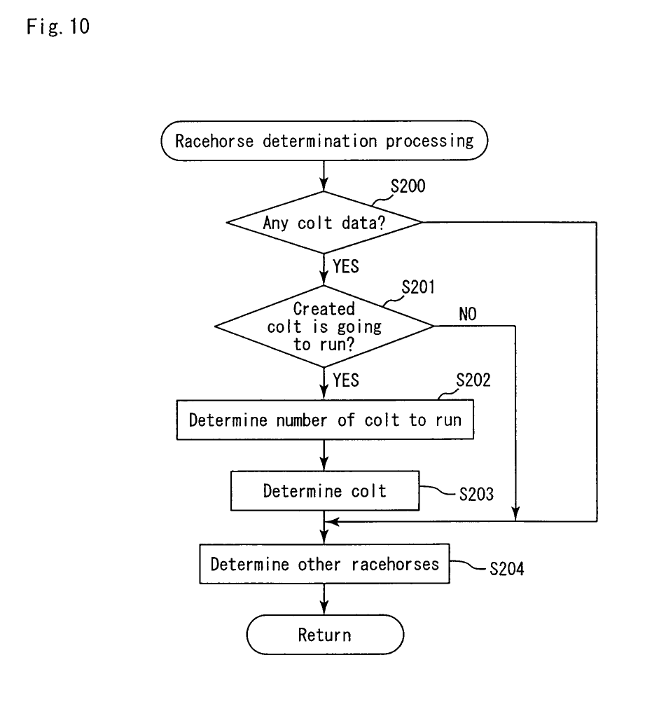

First, in step S100, the CPU 41 executes racehorse determination processing. In this processing, the CPU 41 selects information regarding a prescribed number of (e.g. 6) racehorses out of information regarding a plurality of racehorses stored in the ROM 43, based on random numbers generated by the random number generator 35, and determines those horses as racehorses to run in a race this time around. At this time, the CPU 41 provides starting numbers of “1” to “6” to the racehorses to run. The racehorse determination processing is detailed later using FIG. 10.

Next, in step S101, the CPU 41 executes processing of determining odds per betting ticket system. At this time, the CPU 41 sets odds, based on winning percentage data of each racehorse which is stored in the ROM 43 or RAM 42. Therefore, order-of-finish prediction odds including a racehorse with a high winning probability are set low, whereas order-of-finish prediction odds including a racehorse with a low winning probability are set high.

In step S102, the CPU 41 transmits, to each station 101, race information on the racehorses to run (starter) and odds which have been determined in the processing of steps S100 and S101.

Next, in step S103, the CPU 41 determines whether or not the BET period has been expired. Specifically, the CPU 41 determines whether or not a prescribed period of time has elapsed based upon time information measured by the timer 37.

When determining that the BET period has not been expired, the CPU 41 returns the processing to step S103. On the other hand, when determining that the BET period has been expired, the CPU 41 shifts the processing to step S104.

In step S104, the CPU 41 executes racing game execution processing.

In this racing game execution processing, the VDP 315 determines an order of finish of each racehorse in the racing game, based on a random number generated by the random number generator 35. The VDP 315 then makes an image showing the race progress outputted to the main monitor 21, based on the determined order of finish of each racehorse.

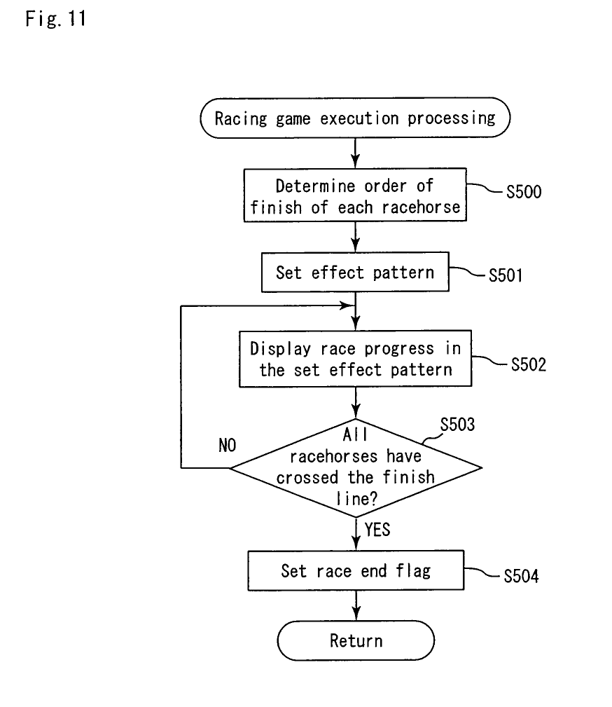

This racing game execution processing is detailed later using FIG. 11.

In step S105, the CPU 41 calculates an amount of payout for each station 101, based on the order of finish of each racehorse which has been determined in the racing game execution processing of step S104 and on a bet information signal transmitted from each station 101 in later-described processing of step S14.

Next, in step S106, the CPU 41 transmits each of the amounts of payout calculated in the processing of step S105 as payout information to each corresponding station 101.

Meanwhile, in each of the stations 101, respective operations of steps S10 to S16 are performed.

First, in step S10, the CPU 131 determines whether or not race information has been received from the main game portion 11. When determining that the race information has not been received, the CPU 131 returns the processing to step S10. On the other hand, when determining that the information has been received, the CPU 131 shifts the processing to step S11.

In step S11, the CPU 131 displays a bet image to the sub-monitor 113, based on the race information transmitted from the CPU 41 (see FIG. 6).

In step S12, the CPU 131 executes BET operation acceptance processing. Specifically, the CPU 131 specifies contents of the bet operation performed by the player based on a coordinate signal from the touch panel driving circuit 122, and stores the contents into the RAM 132. Further, the CPU 131 reflects contents of the BET operation to the display of the BET image displayed on the sub-monitor 113.

The processing of step S12 corresponds to the processing (C) in the present invention. Moreover, step S12 corresponds to the step (C) in the present invention.

In step S13, the CPU 131 determines whether or not a BET has been placed. When determining that a BET has been placed, the CPU 131 shifts the processing to step S14. On the other hand, when determining that a BET has not been placed, the CPU 131 shifts the processing to step S15.

In step S15, the CPU 41 determines whether or not the BET period has been expired. Specifically, the CPU 131 determines whether or not a prescribed period of time has elapsed since the start of acceptance of the BET operation by step S12 based upon time information measured by the timer 126. When determining that the BET period has not been expired, the CPU 131 returns the processing to step S12. On the other hand, when determining that the BET period has been expired, the CPU 131 shifts the processing to step S16.

In step S14, the CPU 131 transmits bet information showing the contents of the bet operation as a bet information signal to the main control portion 12 through the communication interface 125. It is to be noted that the bet information signal includes at least an ID of a racehorse on which the bet has been placed, the number of bet game media, information regarding the type of a betting ticket, and an identification number of the station 101.

After executing the processing of step S14 or when determining in step S15 that the BET period has been expired, the CPU 131 updates the number of credits owned by the player which is stored in the RAM 132 based upon the payout information transmitted by the main game portion 11 (see step S106), and also updates displays in the payout amount display region 220 and the number-of-credits display region 221 of the BET image on the sub-monitor 113 (step S16).

The processing relating to the horse racing game was described above using FIG. 7.

Subsequently, the processing in accordance with the colt creation bonus is described using FIGS. 8 and 9.

First, the processing performed in the station 101 is described.

After executing the processing of step S16 in FIG. 7, the CPU 131 determines whether or not the amount (BET amount) bet in step S12 is a prescribed amount (e.g. 50 credits) or more (step S20). When determining that the BET amount is smaller than the prescribed amount, the CPU 131 completes the present subroutine.

On the other hand, when determining that the BET amount is not smaller than the prescribed amount, the CPU 131 determines whether or not to generate the colt creation bonus, and then determines whether or not the colt creation bonus has been generated as a result of the determination (step S21). The processing of step S21 corresponds to the processing (D) in the present invention, and step S21 corresponds to the step (D) in the present invention.

When determining that the colt creation bonus has not been generated, the CPU 131 completes the present subroutine.

On the other hand, when determining that the colt creation bonus has been generated, the CPU 131 displays on the sub-monitor 113 the selection image 200a shown in FIG. 1A, namely an image prompting the player to select a stallion and a mare (step S22). Specifically, the CPU 131 transmits to the CPU 41 of the station 101 a request signal indicating a request for supply of six stallion data respectively showing six stallions as objects to be selected and six mare data respectively showing six mares as objects to be selected. Upon receipt of the request signal, the CPU 41 selects six stallion data and six mare data out of the plurality of stallion data and the plurality of mare data stored in the ROM 43 by means of random numbers, and supplies the CPU 131 with those data. The CPU 131 generates selection image data showing the selection image 200a based upon the supplied data, and displays on the sub-monitor 113 the selection image 200a based upon the selection image data.

When the selection image 200a is on display on the sub-monitor 113, the player can touch the touch panel to select a stallion and a mare.

The processing of step S22 corresponds to the processing (A) in the present invention, and step S22 corresponds to the step (A) in the present invention.

Next, the CPU 131 determines whether or not a stallion and a mare have been selected (step S23). Specifically, the CPU 131 determines whether or not to have received a selection signal that is outputted when triggered by the operation of the touch panel 114 on the selection image 200a. When determining that a stallion and a mare have been selected, the CPU 131 shifts the processing to step S25.

On the other hand, when determining that a stallion and a mare have not been selected, the CPU 131 determines whether or not a prescribed period of time has elapsed since the display of the selection image 200a. When determining that the prescribed period of time has not elapsed, the CPU 131 returns the processing to step S22. On the other hand, when determining that the prescribed period of time has elapsed, the CPU 131 completes the present subroutine.

In step S25, the CPU 131 displays on the sub-monitor 113 the colt birth image 200b showing a colt and a payout amount. Specifically, the CPU 131 creates colt data based upon the stallion data showing the selected stallion and the mare data showing the selected mare.

In this processing, for example, the CPU 131 averages the speed of the stallion and the speed of the mare, to calculate the speed of the colt. For example, in the example shown in FIGS. 1A and 1B, since the colt was created by the stallion with the stamina of “3” and the speed of “7” and the mare with the stamina of “4” and the speed of “6”, the colt has the stamina of “3.5” and the speed of “6.5”. Then, information showing the thus calculated stamina and speed is included into the colt data.

Further, the CPU 131 determines an amount of payout to be offered in the colt creation bonus by multiplying the sum of the payout amount set corresponding to the selected stallion and the payout amount set corresponding to the selected mare by a scale factor calculated based upon a prescribed program. The prescribed program is, for example, a program to decide a scale factor according to a prescribed calculation formula based upon the stamina and speed of the stallion and the stamina and speed of the mare. In the example shown in FIGS. 1A and 1B, the payout amount set corresponding to the selected stallion is “10 credits”, the payout amount set corresponding to the selected mare is “25 credits” and the scale actor is “5”, and hence the payout amount in the colt creation bonus is 175 credits according to the following equation: (10+25)×5=175.

The processing of step S25 includes the processing (B) and the processing (E) in the present invention, and step S25 includes the step (B) and the step (E) in the present invention.

In the present embodiment, colt data is newly created based upon the stallion data showing the selected stallion and the mare data showing the selected mare. However, in the present invention, colt data may be previously stored corresponding to a combination of a stallion and a mare, and the colt data may be specified based upon the combination of the selected stallion and mare.

Further, in the present embodiment, an amount obtained by multiplying the sum of the payout amount set corresponding to the selected stallion and the payout amount set corresponding to the selected mare by a scale factor calculated based upon a prescribed program is determined as an amount of payout to be offered in the colt creation bonus. However, in the present invention, the method for determining the payout amount in the colt creation bonus is not limited to this example. For example, an amount obtained by adding the payout amount set corresponding to the game object belonging to the first group and the payout amount set corresponding to the game object belonging to the second group as it is may be applied as a payout amount. Further, a payout amount may be previously set for each combination of a game object belonging to the first group and a game object belonging to the second group. Further, a payout may not be offered in the colt creation bonus.

Next, the CPU 131 determines whether or not the determined payout amount is a prescribed amount (150 credits) or more (step S26). When determining that the payout amount is smaller than the prescribed amount, the CPU 131 completes the present subroutine.

On the other hand, when determining the payout amount is not smaller than the prescribed amount, the CPU 131 accepts an input indicating naming of the created colt (step S27). In this processing, the CPU 131, for example, displays an image showing hiragana, Japanese phonetic alphabet, on the sub-monitor 113. The player can input the name by operating the touch panel.

The processing of step S27 corresponds to the processing (F) of the present invention, and step S27 corresponds to the step (F) of the present invention.

Further, the condition that “the payout amount in the colt creation bonus is not smaller than the prescribed amount” corresponds to the prescribed name-input condition in the present invention. The prescribed name-input condition in the present invention is not limited to this example. Examples of the condition may include that a payout amount in a horse racing game is not smaller than a prescribed amount, that horse racing games have been successively played for a prescribed number of times, and the like. As thus described, by employing a condition associated with a horse racing game, it becomes possible to provide an amusing game with the horse racing game and the colt creation bonus integrated together.

Next, the CPU 131 determines whether or not a name has been inputted (step S28). When determining that a name has been inputted, the CPU 131 determines the inputted name as a name of the created colt (step S30). In this processing, the CPU 131 includes information showing the inputted name into the colt data.

On the other hand, when determining that a name has not been inputted, the CPU 131 determines whether or not a prescribed period of time has elapsed since the start of acceptance of the input indicating naming (step S29). When determining that the prescribed period of time has not elapsed, the CPU 131 returns the processing to step S27. On the other hand, when determining that the prescribed period of time has elapsed, the CPU 131 completes the present subroutine.

Next, the CPU 131 accepts the input indicating storage of the created colt data (step S31). In this processing, the CPU 131 displays on the sub-monitor a button image for making the input indicating storage of the colt data. The player can make the input indicating storage of the colt data by touching the touch panel 114 on the button image to make the input indicating storage of the colt data.

Next, the CPU 131 determines whether or not the input indicating storage of the colt data has been made (step S32). When determining that the input indicating storage of the colt data has been made, the CPU 131 shifts the processing to step S34.

On the other hand, when determining that the input indicating storage of the colt data has not been made, the CPU 131 determines whether or not a prescribed period of time has elapsed since the start of acceptance of the input indicating storage of the colt data (step S33). When determining that the prescribed period of time has not elapsed, the CPU 131 returns the processing to step S31. On the other hand, when determining that the prescribed period of time has elapsed, the CPU 131 completes the present subroutine.

In step S34, the CPU 131 transmits a free space inquiry signal to the main game portion 11. The free space inquiry signal is a signal indicating an inquiry on whether or not the number of colt data, that is stored in the colt data storage region 201 provided corresponding to the station 101 having the CPU 131, out of the colt data storage regions 201 provided in the RAM 42, is an upper limit.

Next, the CPU 131 determines whether or not to have received a deletion request signal from the main game portion 11 (step S35). The deletion request signal is a signal indicating a request for deleting any one colt data among the colt data stored in the colt data storage region 201.

The deletion request signal is a signal transmitted from the main game portion 11 when the number of colt data stored in the colt data storage region 201 is the upper limit (see step S111). When this signal is received, in order to store the newly generated colt data in the colt data storage region 201, deletion of any one colt data among the already stored colt data is required. It is to be noted that the deletion request signal includes the colt data stored in the colt data storage region 201.

When determining that the deletion request signal is not received, the CPU 131 completes the present subroutine.

On the other hand, when determining that the deletion request signal has been received, the CPU 131 displays on the sub-monitor 113 a deletion selection image for selecting colt data to be deleted (step S36). In this processing, based upon the colt data included in the deletion request signal, the CPU 131 creates image data showing the deletion selection image, and displays the deletion selection image on the sub-monitor 113 based upon the image data.

When the deletion selection image is on display, the player can select which colt data to delete by touching the touch panel.

Next, the CPU 131 determines whether or not the colt data to be deleted has been selected (step S37). When determining that the colt data to be deleted has been selected, the CPU 131 shifts the processing to step S39.

On the other hand, when determining that the colt data to be deleted has not been selected, the CPU 131 determines whether or not a prescribed period of time has elapsed since the display of the deletion selection image (step S38). When determining that the prescribed period of time has not elapsed, the CPU 131 returns the processing to step S36. On the other hand, when determining that the prescribed period of time has elapsed, the CPU 131 completes the present subroutine.

In step S39, the CPU 131 transmits a deletion selection signal to the main game portion 11. The deletion selection signal is a signal indicating which colt data has been selected as an object to be deleted.

After executing the processing of step S39, the CPU 131 completes the present subroutine.

Out of the processing relating to the colt creation bonus, the processing performed in the station 101 was described above using FIGS. 8 and 9.

Hereinafter, the processing performed in the main game portion 11 is described out of the processing relating to the colt creation bonus.

In step S110 of FIG. 9, the CPU 41 determines whether or not to have received the free space inquiry signal transmitted from the station 101 in step S34. When determining that the free space inquiry signal is not received, the CPU 41 completes the present subroutine.

On the other hand, when determining that the free space inquiry signal has been received, the CPU 41 determines whether or not the number of colt data that is stored in the colt data storage region 201 provided corresponding to the station 101 from which the free space inquiry signal was transmitted, out of the colt data storage regions 201 provided in the RAM 42, is the upper limit (step S111).

When determining that the number of colt data is not the upper limit, the CPU 41 shifts the processing to step S115. On the other hand, when determining that the number of colt data is the upper limit, the CPU 41 transmits the deletion request signal to the station 101 (step S112).

Next, the CPU 41 determines whether or not to have received the deletion selection signal transmitted from the station 101 in step S39 (step S113). When determining that the deletion selection signal is not received, the CPU 41 completes the present subroutine.

On the other hand, when determining that the deletion selection signal has been received, the CPU 41 deletes colt data shown by the deletion selection signal among the colt data stored in the colt data storage region 201 (step S114).

The processing of step S114 corresponds to the processing (I) in the present invention, and step S114 corresponds to the step (I) in the present invention.

After executing the processing of step S114, or when determining that the number of colt data is not the upper limit in step S111, the CPU 41 stores newly created colt data in the colt data storage region 201 (step S115).

The processing of step S115 corresponds to the processing (H) in the present invention, and step S115 corresponds to the step (H) in the present invention.

After executing the processing of step S115, the CPU 41 completes the present subroutine.

FIG. 10 is a flowchart showing a subroutine of the racehorse determination processing executed in the main control portion.

The racehorse determination processing shown in FIG. 10 corresponds to the processing (G) in the present invention. Further, steps S200 to S204 shown in FIG. 10 correspond to the step (G) in the present invention.

First, the CPU 41 determines whether or not the colt data is stored in the colt data storage region 201 (step S200). When determining that the colt data is not stored, the CPU 41 shifts the processing to step S204.

On the other hand, when determining that the colt data is stored, the CPU 41 determines whether or not to make a colt shown by the colt data stored in the colt data storage region 201 run in a race of a horse racing game, and determines, as a result of the determination, whether or not the colt have been determined to run in the race (step S201).

When determining that the colt have been decided not to run in the race, the CPU 41 shifts the processing to step S204. On the other hand, when determining that the colt will run in the race, the CPU 41 shifts the processing to step S202.

In step S202, the CPU 41 determines the number of colts to run in the race by means of random numbers. The CPU 41 then selects colt data in the number determined in step S202 out of all the colt data stored in the RAM 42 based upon random numbers, and determines the selected colts as racehorses to run in the race (step S203).

After executing the processing of step S203, when determining in step S200 that the colt data is not stored, or when determining in step S201 that the colt is decided not to run in the race, the CPU 41 selects racehorses in number required to be 6 that is the number of racehorses to run in the race, out of the plurality of racehorses stored in the ROM 43 (step S204). Namely, when determining in step S200 that the colt data is not stored in step S200, or when determining that the colt is decided not to run in the race, the CPU 41 selects six racehorse, and when determining in step S201 to have determined to make the colt run in the race, the CPU 41 selects racehorse in number obtained by subtracting the number determined in step S202 from 6.

Thereafter, the CPU 41 completes the present subroutine.

FIG. 11 is a flowchart showing a subroutine of racing game execution processing performed in the main control portion.

First, in step S500, the CPU 41 determines an order of finish of each racehorse in the racing game, based on random numbers generated by the random number generator 35.

In step S501, the CPU 41 sets an effect pattern for image display, based on the order of finish of each racehorse determined in the processing of step S500. Then, the CPU 41 supplies the image processing circuit with the set effect pattern.

In step S502, the VDP 315 of the image processing circuit 31 produces effect image data of each racehorse from the start to the finish based on the supplied effect pattern, and also the background image data, the image data of the racehorses and the like which are stored in the image ROM 312. The VDP 315 then outputs an image showing a race process on the main monitor 21 based upon the effect image data produced in the processing of step S501.

Further, the effect image data is supplied from the VDP 315 to the sub-control portion 102 of the station 101 via the CPU 41. The CPU 131 outputs the effect image data to the sub-monitor 113, and consequently, an image showing the progress status of the race is displayed on the sub-monitor 113.

In step S503, the CPU 41 determines whether or not all the racehorses that run in the racing game have crossed the finish line, namely whether or not a prescribed period of time has elapsed since the start of the race. When determining that all the racehorses have not crossed the finish line, the CPU shifts the processing to step S502. On the other hand, when determining that all the racehorses have crossed the finish line, the CPU shifts the processing to step S504.

In step S504, the CPU 41 sets the race end flag. It is to be noted that the race end flag is a flag that is set when a race ends, and is cleared when racehorses to run in a next race are determined.

After executing the processing of step S504, the CPU 41 completes the present subroutine.

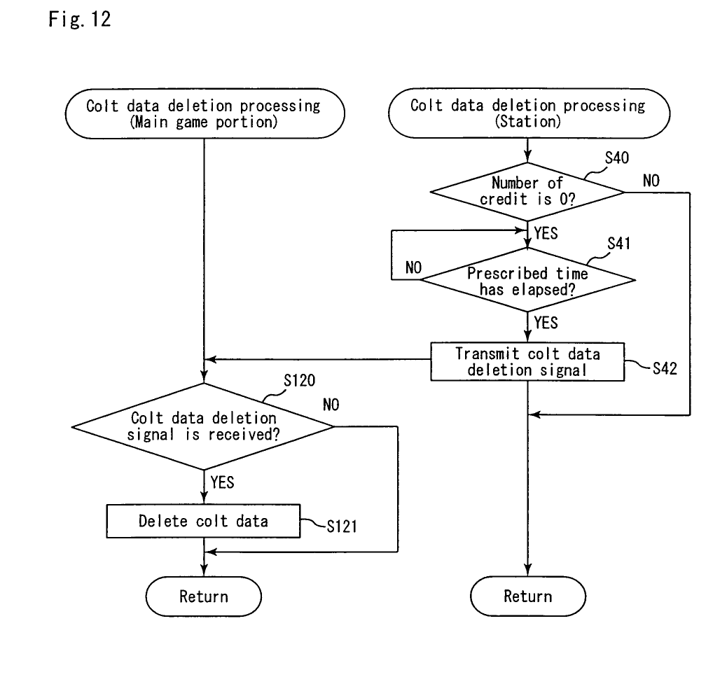

FIG. 12 is a flowchart showing a subroutine of colt data deletion processing performed in the main control portion and the sub-control portion.

First, processing performed in the station 101 is described.

First, the CPU 131 determines at a prescribed timing whether or not the number of credits stored in the RAM 132 is 0 (step S40). When determining that the number of credits is not 0, the CPU 131 completes the present subroutine.

On the other hand, when determining that the number of credits is 0, the CPU 131 determines whether or not a prescribed period of time has elapsed (step S41). When determining that the prescribed time has not elapsed, the CPU 131 returns the processing to step S41.

On the other hand, when determining that the prescribed period of time has elapsed, the CPU 131 transmits a colt data deletion signal to the main game portion 11 (step S42). The colt data deletion signal is a signal indicating deletion of colt data stored in the colt data storage region 201 provided corresponding to the station 101 having the CPU 131.

After executing the processing of step S42, the CPU 131 completes the present subroutine.

Subsequently, processing performed in the main game portion 11 is described.

First, the CPU 41 determines whether or not to have received the colt data deletion signal (step S120). When determining that the colt data deletion signal has not been received, the CPU 41 completes the present subroutine.

On the other hand, when determining that the colt data deletion signal has been received, the CPU 41 deletes colt data stored in the colt data storage region 201 provided corresponding to the station 101 from which the colt data deletion signal was transmitted (step S121). Thereafter, the CPU 41 completes the present subroutine.

The colt data deletion processing shown in FIG. 12 corresponds to the processing (J) in the present invention. Further, steps S40 to S42 and steps S120 to S121 shown in FIG. 12 correspond to the step (J) in the present invention. Further, that “the number of credits is 0 over a prescribed period of time” corresponds to the prescribed game end condition in the present invention. The prescribed game end condition in the present invention is not limited to this example. Examples of the condition may include that a direction to return credits is inputted from the input device such as the payout button.

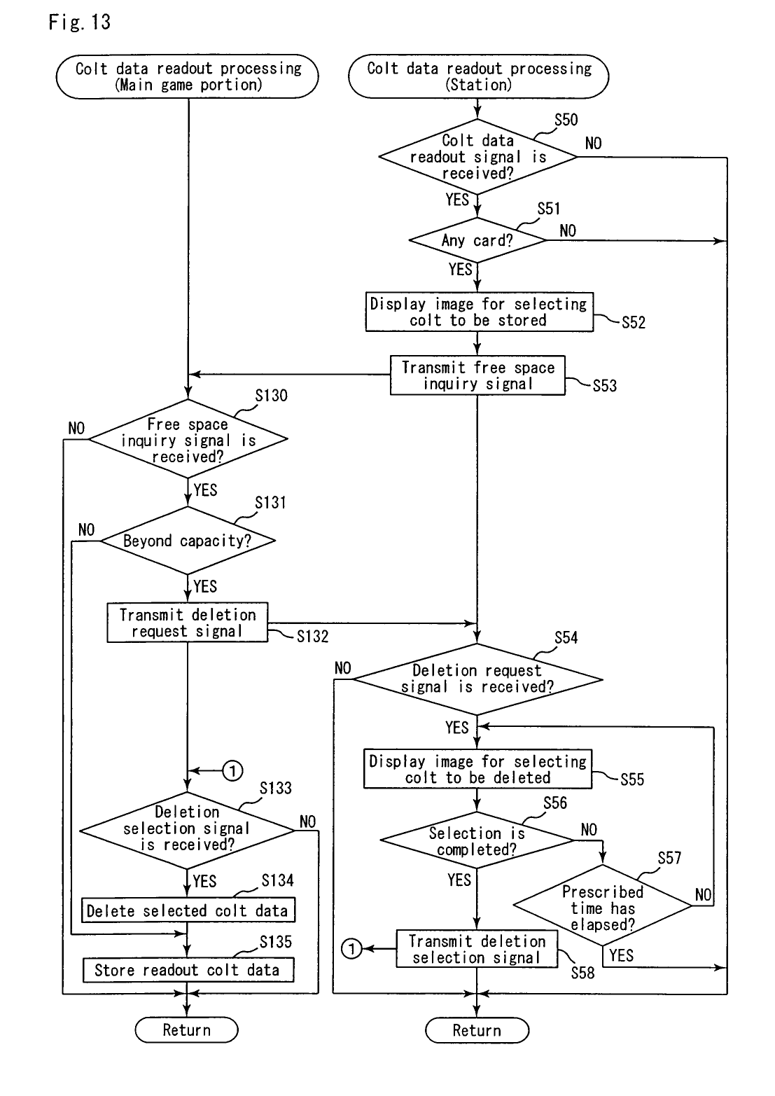

FIG. 13 is a flowchart showing a subroutine of colt data readout processing performed in the main control portion and the sub-control portion.

First, processing performed in the station 101 is described.

The CPU 131 determines whether or not to have received the colt data readout signal at a prescribed timing (step S50). The colt data readout signal is a signal that is transmitted when triggered by pressing of the readout button 151. When determining that the colt data readout signal has not been received, the CPU 131 completes the present subroutine.

On the other hand, when determining that the colt data readout signal has been received, the CPU 131 determines whether or not the memory card 50 is inserted in the memory card insertion portion 150 (step S51). When determining that the memory card 50 is not inserted in the memory card insertion portion 150, the CPU 131 completes the present subroutine.

On the other hand, when determining that the memory card 50 is inserted in the memory card insertion portion 150, the CPU 131 displays on the sub-monitor 113 a readout selection image for selecting a colt shown by colt data to be stored in the colt data storage region 201 (step S52).

When the readout selection image is on display, the player can select which colt data is to be stored in the colt data storage region 201 by touching the touch panel 114.

Next, the CPU 131 transmits a free space inquiry signal to the main game portion 11 (step S53). The free space inquiry signal includes information showing the number of colts selected by the player in step S52. The free space inquiry signal is a signal indicating an inquiry of whether or not the number obtained by adding the number of colt data selected by the player in step S52 to the number of colt data stored in the colt data storage region 201 provided corresponding to the station 101 having the CPU 131, exceeds an upper limit.

Next, the CPU 131 determines whether or not to have received a deletion request signal from the main game portion 11 (step S54). The deletion request signal is a signal indicating a request for deleting any one colt data out of the colt data stored in the colt data storage region 201.

The deletion request signal is a signal transmitted from the main game portion 11 when the number obtained by adding the number of colt data selected by the player in step S52 to the number of colt data stored in the colt data storage region 201 exceeds the upper limit (see step S131). When this signal is received, it is necessary to delete any one colt data out of the already stored colt data in order to store the colt data selected from the memory card 50 into the colt data storage region 201. It is to be noted that the deletion request signal includes the colt data stored in the colt data storage region 201.

When determining that the deletion request signal has not been received, the CPU 131 completes the present subroutine.

On the other hand, when determining that the deletion request signal has been received, the CPU 131 displays on the sub-monitor 113 a deletion selection image for selecting colt data to be deleted (step S55). In this processing, based upon the colt data included in the deletion request signal, the CPU 131 produces image data showing the deletion selection image, and displays the deletion selection image on the sub-monitor 113 based upon the image data.

When the deletion selection image is on display, the player can select which colt data is to be deleted by touching the panel.

Next, the CPU 131 determines whether or not the colt data to be deleted has been selected (step S56). When determining that the colt data to be deleted has been selected, the CPU 131 shifts the processing to step S58.

On the other hand, when determining that the colt data to be deleted has not been selected, the CPU 131 determines whether or not a prescribed period of time has elapsed since the display of the deletion selection image (step S57). When determining that the prescribed period of time has not elapsed, the CPU 131 returns the processing to step S55. On the other hand, when determining that the prescribed period of time has elapsed, the CPU 131 completes the present subroutine.

In step S58, the CPU 131 transmits a deletion selection signal to the main game portion 11. The deletion selection signal is a signal indicating which colt data has been selected as an object to be deleted.

After executing the processing of step S58, the CPU 131 completes the present subroutine.

Subsequently, processing performed in the main game portion 11 is described.

In step S130, the CPU 41 determines whether or not to have received the free space inquiry signal transmitted from the station 101 in step S53. When determining that the free space inquiry signal has not been received, the CPU 41 completes the present subroutine.

On the other hand, when determining that the free space inquiry signal has been received, the CPU 41 determines whether or not the number, obtained by adding the number of colt data selected by the player in step S52 to the number of colt data stored in the colt data storage region 201 provided corresponding to the station 101 from which the free space inquiry signal was transmitted out of the colt data storage region 201 provided in the RAM 42, exceeds the upper limit (step S131).

When determining that the number does not exceed the upper limit, the CPU 41 shifts the processing to step S135. On the other hand, when determining that the number exceeds the upper limit, the CPU 41 transmits a deletion request signal to the station 101 (step S132).

Next, the CPU 41 determines whether or not to have received the deletion selection signal transmitted from the station 101 in step S58 (step S133). When determining that the deletion selection signal has not been received, the CPU 41 completes the present subroutine.

On the other hand, when determining that the deletion selection signal has been received, the CPU 41 deletes colt data shown by the deletion selection signal out of the colt data stored in the colt data storage region 201 (step S134).

After executing the processing of step S134 or when determining in step S131 that the number does not exceed the upper limit, the CPU 41 stores the data read from the memory card 50 into the colt data storage region 201 (step S135).

Thereafter, the CPU 41 completes the present subroutine.

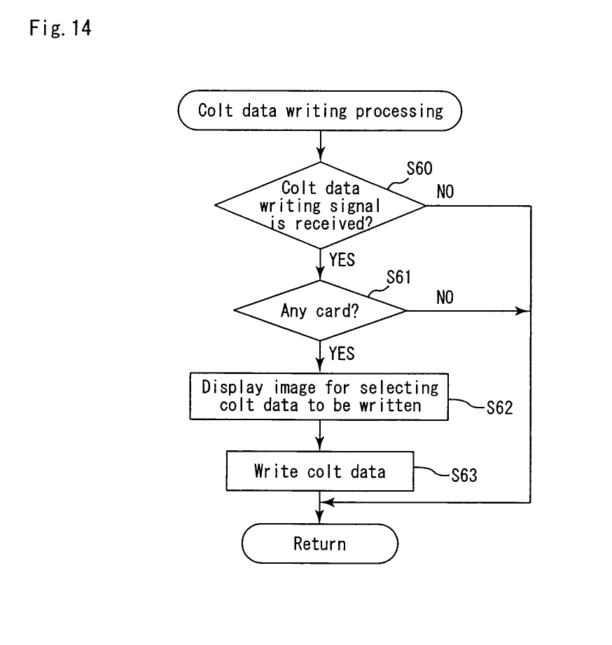

FIG. 14 is a flowchart showing a subroutine of colt data writing processing performed in the sub-control portion.

The CPU 131 determines whether or not to have received the colt data writing signal at a prescribed timing (step S60). The colt data writing signal is a signal that is transmitted as triggered by pressing of the writing button 152. When determining that the colt data writing signal has not been received, the CPU 131 completes the present subroutine.

On the other hand, when determining that the colt data writing signal has been received, the CPU 131 determines whether or not the memory card 50 is inserted in the memory card insertion portion 150 (step S61). When determining that the memory card 50 is not inserted in the memory card insertion portion 150, the CPU 131 completes the present subroutine.

On the other hand, when determining that the memory card 50 is inserted in the memory card insertion portion 150, the CPU 131 displays on the sub-monitor 113 a writing selection image for selecting colt data to be stored into the memory card 50 (step S62). In this processing, the CPU 131 receives from the main game portion 11 a supply of colt data stored in the colt data storage region 201 provided corresponding to the station 101 having the CPU 131. The CPU 131 then produces image data showing the writing selection image based upon the colt data, and displays the writing selection image based upon the image data.

When the writing selection image is on display, the player can select which colt data is to be stored in the memory card 50 by touching the touch panel 114.

Next, the CPU 131 stores the colt data selected in step S62 into the memory card 50 (step S63). The processing of step S63 corresponds to the processing (K) in the present invention, and step S63 corresponds to the step (K) in the present invention.

After executing the processing of step S63, the CPU 131 completes the present subroutine.

In the above, according to the horse racing game apparatus 1 of the present embodiment, a plurality of game objects appear in a game. The plurality of game objects include game objects (racehorses) to run in a race of a horse racing game, game objects (stallions) belonging to the first group and game objects (mares) belonging to the second group.

During the game, respective inputs indicating selection of a stallion and a mare are accepted at a prescribed timing. Based upon stallion data showing the selected stallion and mare data showing the selected mare, colt data showing a special game object (colt) different from either the stallion or the mare is produced.

Hence the player can produce a colt based upon the stallion and the mare of his or her own selection. Since the player himself or herself is involved in creation of the colt, the player feels attached to the colt and can easily empathize with the game. Therefore, according to the horse racing game apparatus 1 of the present embodiment, it is possible to prevent the player from getting bored of the game in a short period of time, and make the player absorbed in the game.

Further, in the horse racing game apparatus 1 according to the present embodiment, at the station 101 that satisfies a prescribed condition, a colt creation bonus is generated. Therefore, since only a player playing a game at the station that satisfies the prescribed condition can create a colt, it is possible to provide such a player with feelings of superiority and satisfaction, so as to make him or her fully enjoy the game.

Further, in the horse racing game apparatus 1 according to the present embodiment, the colt creation bonus is generated only at the station 101 where game media were bet in amount not smaller than a prescribed amount. Therefore, it is possible to prompt the player to bet game media in amount not smaller than the prescribed amount, so as to increase a profit of a gaming facility.

Further, according to the horse racing game apparatus 1 of the present embodiment, whether or not to generate the colt creation bonus is determined based upon a prescribed probability after completion of the race of the horse racing game. Therefore, since the timing at which the colt can be created is not previously determined, it is possible to make the player play a game while always expecting for the timing. When such a timing arrives, the player can feel a great joy and a certain kind of surprise so that it becomes possible to provide an extremely attractive game.

Further, according to the horse racing game apparatus 1 of the present embodiment, a payout is offered based upon the selected stallion and mare. Therefore, the player can create the colt and also acquire game media, so as to obtain a great feeling of satisfaction.

Further, according to the horse racing game apparatus 1 of the present embodiment, payout amounts are respectively set corresponding to the stallion and the mare. Then, an amount obtained by multiplying the sum of the payout amount set corresponding to the selected stallion and the payout amount set corresponding to the selected mare by a number specified by a combination of the stallion and the mare is offered as a payout.

Accordingly, the amount of the payout to be offered is influenced not simply by the payout amounts set corresponding to the stallion and the mare as the objects to be selected, but also by a combination of the selected stallion and the selected mare. For this reason, the player carefully considers which combination of the stallion and the mare leads to acquirement of game media in as large an amount as possible. The player can experience a variety of emotional ups and downs through the game, for example, the player is shocked when only a small amount of game media is offered, and on the other hand, the player feels pleasure when a large amount of payout is offered. By going through the aforementioned process, the player can fully enjoy the game.

Further, according to the horse racing game apparatus 1 of the present embodiment, an input indicating naming of a colt is accepted when a prescribed name-input condition is satisfied. Since the player can name the colt created by himself or herself, the player further feels attached to the colt and can further easily empathize with the game.

Further, according to the horse racing game apparatus 1 of the present embodiment, in a case where the payout amount that is offered when the stallion and the mare are selected is not smaller than a prescribed amount, an input indicating naming of the colt is accepted. Therefore, which stallion and mare to select is important matter for the player, since it involves not only the amount of payout but also whether or not the privilege of naming a colt will be given. By going through the important selection, the player can enjoy sense of tension and, when the player can select a combination of the stallion and the mare corresponding to a large payout amount, the player further enjoy sense of joy and accomplishment.

Further, according to the horse racing game apparatus 1 of the present embodiment, colt data is stored into the colt data storage region 201 provided in the RAM 42. When the colt data has been stored in the colt data storage region 201, racehorses to run in a race are selected out of the colt shown by the colt data and the plurality of racehorses.

As thus described, according to the horse racing game apparatus 1 of the present embodiment, the opportunity to participate in the racing game is also given to the colt. When the colt created by himself or herself runs in the race, the player feels attached to the colt and empathizes with and is excited over the game to an enormous degree. The player can fully enjoy the game by placing a BET on and cheer for the colt created by himself or herself.

Further, according to the horse racing game apparatus 1 of the present embodiment, an upper limit is set for the number of colt data that can be stored in the colt data storage region 201. In a case where colt data is further determined when the colt data in the number indicated by the upper limit has been stored in the colt data storage region 201, any of the colt data stored in the colt data storage region 201 is deleted.

As thus described, according to the horse racing game apparatus 1 of the present embodiment, since the number of colt data does not become a given number or larger, it is possible to keep a memory space used for storing the colt data within a given range, and also to prevent a decrease in scarcity value of colt data with the possibility to unlimitedly store the colt data.

Further, according to the horse racing game apparatus 1 of the present embodiment, when a prescribed game end condition is established, the colt data stored in the colt data storage region 201 is deleted. Therefore, when the player completes the game, the colt created by the player will no longer run in the race. A colt is not familiar for players other than the player having created the colt. According to the horse racing game apparatus 1 of the present embodiment, it is possible to avoid a situation in which such an unfamiliar colt runs to offend other players.

Further, according to the horse racing game apparatus 1 of the present embodiment, the colt data stored in the colt data storage region 201 can be stored in the memory card 50. Thereby, the player can store the colt created by himself or herself in the memory card 50 of his or her own. Then, when a next game is played on the gaming apparatus 1, by reading the memory card 50, it is possible to make the colt again appear in the game. Hence the player can perpetually enjoy the game by the use of the once acquired colt.

In the present embodiment, the case of applying the present invention to the horse racing game apparatus 1 has been described, but in the present invention, a bike racing game apparatus, a boat racing game apparatus, a dog racing game apparatus, a car racing game apparatus, a motorcycle racing game apparatus, or the like may be adopted. In the case of forming such a configuration, bikes, motorboats, dogs, cars, or motorcycles correspond to the race objects in the present invention.

Although the embodiment of the present invention has been described above, it just presents a specific example, and does not particularly limit the present invention. A specific configuration of each unit or the like can be appropriately changed in terms of design. Further, the description of the effects made in the embodiment of the present invention are only recitation of the most preferable effects that arise from the present invention, and the effects according to the present invention are not limited to those described in the embodiment of the present invention.

What is claimed as new and desired to be secured by Letters Patent of the United States is:

1. A gaming apparatus, comprising:
an input device with which a player can input a command;
a storage device that stores a plurality of game object data showing a plurality of game objects appearing in a game; and
a controller,
said gaming apparatus providing a racing game in which a plurality of race objects selected from said plurality of game objects contend with one another for winning,
said plurality of game objects shown by the plurality of game object data stored in said storage device including a plurality of game objects belonging to a first group and a plurality of game objects belonging to a second group different from said first group,
said controller being programmed to execute processing of
(A) accepting from said input device respective inputs indicating selection of one game object belonging to said first group and one game object belonging to said second group, and
(B) determining special game object data showing a special game object different from either the one game object belonging to the first group which has been selected in said processing (A) or the one game object belonging to the second group which has been selected in said processing (A), based on the respective game object data showing those game objects.

2. The gaming apparatus according to claim 1,
wherein
said input device is provided in each of a plurality of stations, and
said processing (A) is processing of accepting respective inputs indicating selection of one game object belonging to said first group and one game object belonging to said second group, from the input device provided in the station that satisfies a prescribed condition.

3. The gaming apparatus according to claim 2,
wherein
said input device is a device with which a player can input a BET on said racing game,
said controller is further programmed to execute processing of
(C) accepting the BET on said racing game from each of said input devices, and
said prescribed condition is that a BET of game media is inputted in an amount not smaller than a prescribed amount from the input device in said processing (C).

4. The gaming apparatus according to claim 2,
wherein
said controller is further programmed to execute processing of
(D) determining whether or not to accept the inputs in said processing (A) at a prescribed timing, and
said prescribed condition is that acceptance of said inputs has been determined in said processing (D).

5. The gaming apparatus according to claim 1,
wherein
said controller is further programmed to execute processing of
(E) offering an award based on the game objects selected in said processing (A).

6. The gaming apparatus according to claim 5,
wherein
a payout amount is correspondingly set for each of the game objects belonging to said first group and each of the game objects belonging to said second group, and
the amount of payout offered in said processing (E) is an amount obtained by multiplying the sum of the payout amount set corresponding to the game object belonging to the first group which was selected in said processing (A) and the payout amount set corresponding to the game object belonging to the second group which was selected in said processing (A), by a number specified by a combination of those game objects.

7. The gaming apparatus according to claim 5,
wherein
said controller is further programmed to execute processing of
(F) accepting from said input device an input indicating naming of the special game object shown by the special game object data determined in said processing (B) when a prescribed name-input condition is satisfied.

8. The gaming apparatus according to claim 7,
wherein
said prescribed name-input condition is that the amount of payout offered in said processing (E) is not smaller than a prescribed amount.

9. The gaming apparatus according to claim 1, comprising
a special storage device capable of storing said special game object data,
wherein
said controller is further programmed to execute processing of
(G) selecting a plurality of race objects to participate in said racing game at least out of a plurality of game objects shown by a plurality of the game object data stored in said storage device, and
(H) storing the special game object data determined in said processing (B) in said special storage device, and
said processing (G) is processing of selecting said plurality of race objects out of the special game object shown by said special game object data and the plurality of game objects shown by said plurality of game object data when the special game object data is stored in the special storage device in said processing (H).

10. The gaming apparatus according to claim 9,
wherein
an upper limit is set for the number of said special game object data that can be stored in said special storage device, and
said controller is further programmed to execute processing of
(I) deleting any of the special game object data stored in said special storage device based on an input from said input device when the special game object data is determined in said processing (B) in a case where said special game object data are stored in number indicated by said upper limit in said special storage device.

11. The gaming apparatus according to claim 9,
wherein
said controller is further programmed to execute processing of
(J) deleting the special game object data stored in said storage device in said processing (H), when a prescribed game completion condition is established.

12. The gaming apparatus according to claim 9, comprising
an insertion/removal portion, into and from which an external storage device capable of storing said special game object data can be inserted or removed, and
said controller is further programmed to execute processing of
(K) storing the special game object data, stored in the special storage device by said processing (H), into the external storage device inserted in said insertion/removal portion.

13. A game controlling method providing a racing game in which a plurality of race objects, selected from a plurality of game objects appearing in a game, contend with one another for winning,
said plurality of game objects including a plurality of game objects belonging to a first group and a plurality of game objects belonging to a second group different from said first group,
said game controlling method including the steps of
(A) accepting respective inputs indicating selection of one game object belonging to said first group and one game object belonging to said second group, and
(B) determining special game object data showing a special game object different from either the one game object belonging to the first group which has been selected in said step (A) or the one game object belonging to the second group which has been selected in said step (A), based on the respective game object data showing those game objects.

14. The game controlling method according to claim 13,
wherein
said step (A) is a step of accepting respective inputs indicating selection of one game object belonging to said first group and one game object belonging to said second group in the station that satisfies a prescribed condition.

15. The game controlling method according to claim 14, including a step of
(C) accepting the BET on said racing game,
wherein
said prescribed condition is that a BET of game media is placed in an amount not smaller than a prescribed amount.

16. The game controlling method according to claim 14, including a step of
(D) determining whether or not to accept the inputs in said step (A) at a prescribed timing,
wherein
said prescribed condition is that acceptance of said inputs has been determined in said step (D).

17. The game controlling method according to claim 13, including a step of
(E) offering an award based on the game objects selected in said step (A).

18. The game controlling method according to claim 17,
wherein
a payout amount is correspondingly set for each of the game objects belonging to said first group and each of the game objects belonging to said second group, and
the amount of payout offered in said step (E) is an amount obtained by multiplying the sum of the payout amount set corresponding to the game object belonging to the first group which was selected in said step (A) and the payout amount set corresponding to the game object belonging to the second group which was selected in said step (A), by a number specified by a combination of those game objects.

19. The game controlling method according to claim 17, including a step of
(F) accepting from an input device an input indicating naming of the special game object shown by the special game object data determined in said step (B) when a prescribed name-input condition is satisfied.

20. The game controlling method according to claim 19,
wherein
said prescribed name-input condition is that the amount of payout offered in said step (E) is not smaller than a prescribed amount.

21. The game controlling method according to claim 13, including the steps of
(G) selecting a plurality of race objects to participate in said racing game at least out of a plurality of the game objects shown by a plurality of game object data stored in said storage device, and
(H) storing the special game object data determined in said step (B) in a special storage device, wherein
said step (G) is a step of selecting said plurality of race objects out of the special game object shown by said special game object data and the plurality of game objects shown by said plurality of game object data when the special game object data is stored in the special storage device in said step (H).

22. The game controlling method according to claim 21,
wherein
an upper limit is set for the number of said special game object data that can be stored in said special storage device, and
said method includes a step of
(I) deleting any of the special game object data stored in said special storage device based on an input from said input device when the special game object data is determined in said step (B) in a case where said special game object data are stored in number indicated by said upper limit in said special storage device.

23. The game controlling method according to claim 21, including a step of
(J) deleting the special game object data stored in the special storage device in said step (H), when a prescribed game completion condition is established.

24. The game controlling method according to claim 21, including a step of
(K) storing the special game object data stored in the special storage device in said step (H), in the external storage device inserted in an insertion/removal portion, into and from which the external storage device can be inserted and removed.
